(19) United States
(12) Patent Application Publication
(10) Pub. No.: US 2011/0236799 A1
(43) Pub. Date: Sep. 29, 2011

(54) MANUFACTURING METHODS FOR AIR ELECTRODE

(75) Inventors: Trygve Burchardt, Vancouver, WA (US); Adam Laubach, Kingwood, TX (US); Anne-Laure Becquet, Portland, OR (US); Christopher Pedicini, Nashville, TN (US); James P. McDougall, Henderson, NV (US)

(73) Assignee: ReVolt Technology Ltd.

(21) Appl. No.: 13/026,054

(22) Filed: Feb. 11, 2011

Related U.S. Application Data
(63) Continuation-in-part of application No. 12/847,890, filed on Jul. 30, 2010.
(60) Provisional application No. 61/304,273, filed on Feb. 12, 2010.

(51) Int. Cl. H01M 4/96; H01M 4/86; B05D 5/12

(52) U.S. Cl. 429/534; 429/523; 427/77

(57) ABSTRACT

Methods of forming an air electrode of a metal-air battery are provided. One method includes forming a plurality of layers of the air electrode. The plurality of layers include an active layer and a gas diffusion layer. Forming at least one of the active layer or the gas diffusion layer includes forming a first sublayer having a first concentration of a first material and forming a second sublayer having at least one of a second concentration of the first material that differs from the first concentration or a second material that differs from the first material. In another embodiment, a method includes forming a layer of an air electrode such that a gradient of a material is formed in at least a portion of the layer by varying a concentration of the material deposited between a first portion of the layer and a second portion of the layer.

### CROSS-REFERENCE TO RELATED PATENT APPLICATIONS

The present application is a continuation-in-part of U.S. patent application No. 12/847,890, filed Jul. 30, 2010, and also claims priority to and the benefit of U.S. Provisional Patent Application No. 61/304,273, filed Feb. 12, 2010. The entire disclosures of U.S. Provisional Patent Application No. 61/304,273 and U.S. patent application Ser. No. 12/847,890 are incorporated herein by reference.

### BACKGROUND

The present application relates generally to the field of batteries and components for batteries. More specifically, the present application relates to the use of processes, materials, and structures/components to manage the interaction between the internal chemical reaction in a metal-air battery and the external environment. The concepts disclosed herein are further applicable to metal-air fuel cells.

Metal-air batteries include a negative metal electrode (e.g., zinc, aluminum, magnesium, iron, lithium, etc.) and a positive electrode having a porous structure with catalytic properties for an oxygen reaction (typically referred to as the air electrode for the battery). An electrolyte is used to maintain high ionic conductivity between the two electrodes. For alkaline metal-air batteries (i.e., having an alkaline electrolyte), the air electrode is usually made from thin, porous polymeric material (e.g., polytetrafluoroethylene) bonded carbon layers. To prevent a short circuit of the battery, a separator is provided between the negative electrode (anode) and the positive electrode (cathode).

On discharging metal-air batteries, oxygen from the atmosphere is converted to hydroxyl ions in the air electrode. The hydroxyl ions then migrate to the metal electrode, where they cause the metal of the negative electrode to oxidize. The desired reaction in the air electrode involves the reduction of oxygen, the consumption of electrons, and the production of hydroxyl ions. The hydroxyl ions migrate through the electrolyte towards the metal electrode, where oxidation of the metal occurs, forming oxides and liberating electrons. In a secondary (i.e., rechargeable) metal-air battery, charging converts hydroxyl ions to oxygen in the air electrode, releasing electrons. At the metal electrode, the metal oxides or ions are reduced to form the metal while electrons are consumed.

Metal-air batteries provide significant energy capacity benefits. For example, metal-air batteries have several times the energy storage density of lithium-ion batteries, while using globally abundant and low-cost metals (e.g., zinc) as the energy storage medium. The technology is relatively safe (non-flammable) and environmentally friendly (non-toxic and recyclable materials may be used). Since the technology uses materials and processes that are readily available in the U.S. and elsewhere, dependence on scarce resources such as oil may be reduced.

A metal-air battery is a partially open system, where the air electrode interacts with the environment. While a metal-air battery utilizes oxygen from its surrounding environment, it may also be limited by other elements/factors of its surrounding environment. Environmental elements/factors such as humidity and the presence of carbon dioxide (CO₂) can significantly shorten the lifespan of metal-air batteries, in many cases limiting their possible applications.

It would be advantageous to provide an improved battery and structures/features therefore that address one or more of the foregoing issues. It would be advantageous to provide processes, techniques, constructions, materials and/or devices for constructing air electrodes and/or other components of metal-air batteries having improved performance. Other advantageous features will be apparent to those reviewing the present disclosure.

### SUMMARY

An exemplary embodiment relates to a method of providing an air electrode for a metal-air battery. The method includes forming a plurality of layers of the air electrode. The plurality of layers include an active layer and a gas diffusion layer. Forming at least one of the active layer or the gas diffusion layer includes forming a first sublayer having a first concentration of a first material and forming a second sublayer having at least one of a second concentration of the first material that differs from the first concentration or a second material that differs from the first material.

In some embodiments, the first sublayer and the second sublayer may be part of the active layer and at least one of the first material or the second material may be a catalyst material. In some embodiments, the method may include providing an electrolyte in the metal-air battery and providing the air electrode in the metal-air battery such that the first sublayer is nearer to the electrolyte than the second sublayer. The first concentration may be higher than the second concentration.

In some embodiments, the first sublayer and the second sublayer may be part of the active layer and at least one of the first material or the second material may be a surfactant material. In some embodiments, the method may include providing an electrolyte in the metal-air battery and providing the air electrode in the metal-air battery such that the first sublayer is nearer to the electrolyte than the second sublayer. The first sublayer may be formed using a first surfactant material and the second sublayer may be formed using a second surfactant material. The first surfactant material may include surfactants that are removable at a higher temperature than surfactants of the second surfactant material.

In some embodiments, the method may include providing an electrolyte in the metal-air battery and providing the air electrode in the metal-air battery such that the first sublayer is nearer to the electrolyte than the second sublayer. The first sublayer may be formed using a non-carbon material and the second sublayer is formed using a carbon material.

In some embodiments, the method may include printing a hydrophobic layer about a periphery of at least one of the first sublayer and the second sublayer.

Another exemplary embodiment relates to a metal-air battery comprising an air electrode including a plurality of layers. The plurality of layers comprise an active layer and a gas diffusion layer. At least one of the active layer or the gas diffusion layer comprises a first sublayer having a first concentration of a first material and a second sublayer having at least one of a second concentration of the first material that differs from the first concentration or a second material that differs from the first material.

In some embodiments, the first sublayer and the second sublayer may be part of the active layer and at least one of the first material or the second material may be a catalyst material. In some embodiments, the metal-air battery includes an electrolyte and the air electrode is provided such that the first sublayer is nearer to the electrolyte than the second sublayer. The first concentration may be higher than the second concentration.

In some embodiments, the first sublayer and the second sublayer may be part of the active layer and at least one of the first material or the second material may be a surfactant material. In some embodiments, the metal-air battery includes an electrolyte and the air electrode is provided such that the first sublayer is nearer to the electrolyte than the second sublayer. The first sublayer may include first surfactant material and the second sublayer comprises a second surfactant material, and the first surfactant material may include surfactants that are removable at a higher temperature than surfactants of the second surfactant material.

In some embodiments, the the metal-air battery includes an electrolyte and the air electrode is provided such that the first sublayer is nearer to the electrolyte than the second sublayer. The first sublayer may include a non-carbon material and the second sublayer may include a carbon material.

In some embodiments, the air electrode may include a hydrophobic layer positioned about a periphery of at least one of the first sublayer and the second sublayer.

Another exemplary embodiment relates to a method of forming an air electrode of a metal-air battery. The method comprises forming a layer of an air electrode such that a gradient of a material is formed in at least a portion of the layer by varying a concentration of the material deposited between a first portion of the layer and a second portion of the layer.

In some embodiments, the material may include a first material, and the gradient may be formed by forming a first sublayer having a first concentration of the material and forming a second sublayer having at least one of a second concentration of the first material that differs from the first concentration or a second material that differs from the first material.

In some embodiments, the first sublayer and the second sublayer may be part of the active layer and at least one of the first material or the second material may be a catalyst material. In some embodiments, the method may include providing an electrolyte in the metal-air battery and providing the air electrode in the metal-air battery such that the first sublayer is nearer to the electrolyte than the second sublayer. The first concentration may be higher than the second concentration.

In some embodiments, the first sublayer and the second sublayer may be part of the active layer and at least one of the first material or the second material may be a surfactant material. In some embodiments, the method may include providing an electrolyte in the metal-air battery and providing the air electrode in the metal-air battery such that the first sublayer is nearer to the electrolyte than the second sublayer. The first sublayer may be formed using a first surfactant material and the second sublayer may be formed using a second surfactant material. The first surfactant material may include surfactants that are removable at a higher temperature than surfactants of the second surfactant material.

In some embodiments, the method may include providing an electrolyte in the metal-air battery and providing the air electrode in the metal-air battery such that the first sublayer is nearer to the electrolyte than the second sublayer. The first sublayer may be formed using a non-carbon material and the second sublayer is formed using a carbon material.

In some embodiments, the method may include printing a hydrophobic layer about a periphery of at least one of the first sublayer and the second sublayer.

### BRIEF DESCRIPTION OF THE DRAWINGS

FIG. 1 is a perspective view of a metal-air battery in the form of a coin cell according to an exemplary embodiment.

FIG. 2 is a cross-sectional view of the metal-air battery shown in FIG. 1.

FIG. 3 is a perspective view of a metal-air battery having a prismatic configuration according to an exemplary embodiment.

FIG. 4 is a cross-sectional view of the metal-air battery shown in FIG. 3.

FIG. 5 is detail cross-sectional view of the cross-section shown in FIG. 4.

FIG. 6 is a partially exploded perspective view of a flow battery according to an exemplary embodiment.

FIG. 7 is a schematic view of a multi-layer air electrode according to an exemplary embodiment.

FIG. 8 is a sectional view of a plurality of sublayers of the gas diffusion layer of the multi-layer air electrode shown in FIG. 7.

FIG. 9 is a sectional view of a plurality of sublayers of the active layer of the multi-layer air electrode shown in FIG. 7.

FIG. 10 is a flow diagram of a screen printing process for an air electrode according to an exemplary embodiment.

FIG. 11 is a flow diagram of a spray printing process for an air electrode according to an exemplary embodiment.

FIG. 12 is a flow diagram of a spin coating process for an air electrode according to an exemplary embodiment.

FIG. 13 is a cross-sectional view of a metal-air battery similar to that shown in FIG. 2.

FIG. 14 is a schematic view of an air electrode according to another exemplary embodiment.

FIG. 15 is a cross-sectional view of the air electrode of FIG. 14 taken along line 15-15.

FIG. 16 is a detail view of FIG. 15 taken along line 16-16.

FIG. 17 is an alternative detail view of FIG. 15 taken along line 16-16.

FIG. 18 is cross-sectional view of a metal-air flow cell according to an exemplary embodiment.

FIG. 19 is a perspective view of a reaction tube of the metal-air flow cell of FIG. 18 according to an exemplary embodiment.

FIG. 20 is a schematic view of an air electrode according to another exemplary embodiment.

FIG. 21 is a schematic view of an air electrode during discharge according to another exemplary embodiment.

FIG. 22 is a schematic view of an air electrode during charge according to another exemplary embodiment.

FIG. 23 is an exploded schematic view of an air electrode including a printed current collector according to an exemplary embodiment.

FIG. 24 is a cross-sectional view of a portion of a battery having a housing formed at least in part of an air electrode according to an exemplary embodiment.

FIG. 25 is a schematic view of an injection molding machine that may be used to produce air electrodes or components thereof according to an exemplary embodiment.

FIG. 26 is a schematic view of a screw extruder that may be used to produce air electrodes or components thereof according to an exemplary embodiment.

FIG. 27 is a schematic view of a portion of a screw extruder that may be used to produce air electrodes or components thereof according to another exemplary embodiment.

FIG. 28 is a schematic view of a slot die extruder that may be used to produce air electrodes or components thereof according to an exemplary embodiment.

### DETAILED DESCRIPTION

According to an exemplary embodiment, a metal-air battery or cell having improved performance and/or that is viable in new applications is described herein. Improved and/or new processes for producing air electrodes and/or other battery components are also described herein. These processes may be utilized to obtain new and/or improved constructions and new applications for metal-air batteries and components thereof.

According to some exemplary embodiments, at least a portion of a metal-air battery may be formed using one of a variety of processes. The processes may include screen printing, spray printing, spin coating, dip coating, screw extrusion, injection molding, and/or other types of processes. In some embodiments, some portions of a metal-air battery may be formed using one type of process (e.g., screen printing) and other portions of the metal-air battery may be formed using another type of process (e.g., spin coating).

According to some exemplary embodiments, these processes may be used to form one or more layers of an air electrode. In some embodiments, the layers (e.g., active layer, gas diffusion layer, etc.) may have one or more sublayers. In some embodiments, the processes may be used to form a gradient of material in a layer and/or sublayer by varying a type and/or concentration of material deposited in different portions of the layer and/or sublayer.

According to an exemplary embodiment, these processes may be used to form one or more blank portions or vents in a layer and/or sublayer of an air electrode. The blank portions or vents may provide locations at which gases have less of a layer (or no layer) through which they must pass to exit the metal-air battery. These blank portions or vents may allow gases to more readily exist the metal-air battery and reduce the likelihood that gases will be trapped in the battery. Improved ventilation helps prevent leakage, drying out of a metal-air battery, a loss in the power density and efficiency of a metal-air battery, and/or other problems associated with gases trapped in a metal-air battery.

According to one exemplary embodiment, processes described herein may be used to form an air electrode that forms all or a portion of the external housing of a metal-air battery. This may have particular utility with electronic devices such as cellular phones, personal digital assistants (PDAs), and the like. In this manner, the outer surface of the battery may act both as the housing and as an air electrode, and the oxygen from the surrounding environment may be evenly distributed over the entire air electrode since there is no housing between the air electrode and the environment. According to an exemplary embodiment, the external surface of the metal-air battery that is defined by the air electrode may be positioned such that the external surface also forms a portion of an external surface of a device in which the battery is used (e.g., the air electrode that defines a portion of the housing may also serve as a portion of the outer surface of the housing for a cellular phone, in which case the air electrode would be directly in contact with the environment outside the phone).

The metal-air battery may have any desired configuration, including, but not limited to coin or button cells, prismatic cells, cylindrical cells (e.g., AA, AAA, C, or D cells in addition to other cylindrical configurations), flow cells, fuels cells, etc. Further, the metal-air battery may be a primary (disposable, single-use) or a secondary (rechargeable) battery. Rechargeable metal-air batteries are available due to the development of bifunctional air electrodes and the utilization of rechargeable anode materials.

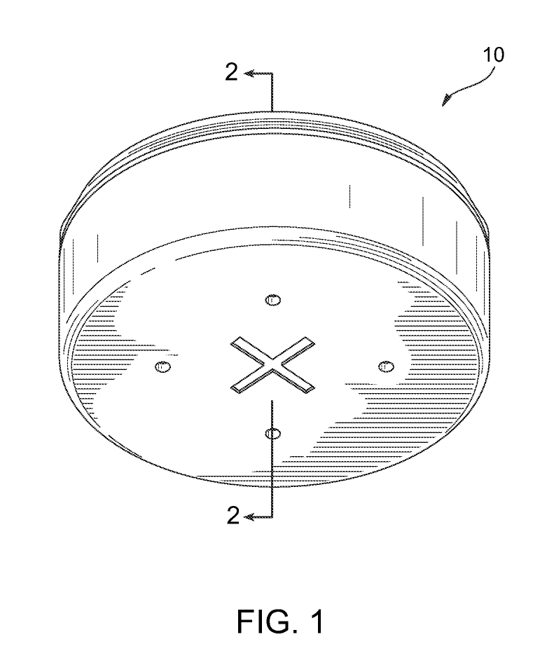

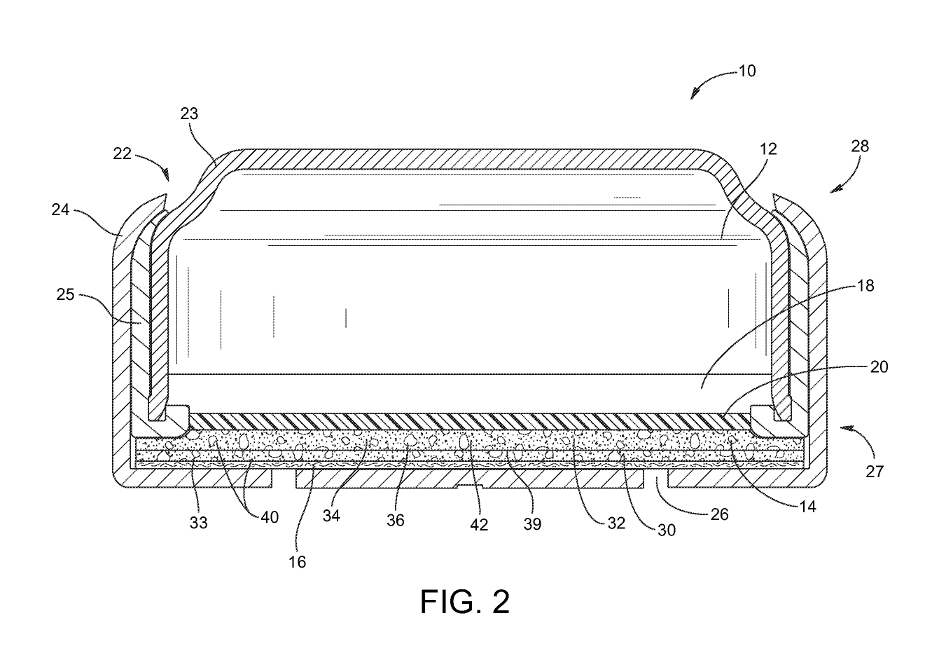

Referring to FIGS. 1-2, a metal-air battery 10 shown as a coin or button cell is illustrated according to an exemplary embodiment.

Referring to FIG. 2, the battery 10 includes a metal electrode 12, an air electrode 14 including a gas diffusion layer 30 and an active layer 32 (the active layer possibly also including an oxygen evolution layer), an electrolyte 18, a separator 20, an oxygen distribution layer 16 (e.g., a non-woven fibrous material intended to distribute oxygen entering the system evenly throughout the air electrode 14), and an enclosing structure shown as a housing 22 according to an exemplary embodiment.

According to an exemplary embodiment, the battery 10 is a zinc-air battery. According to other exemplary embodiments, the battery 10 may use other metals in place of the zinc, including, but not limited to, aluminum, magnesium, iron, lithium, cadmium, and/or a metal hydride. Examples of metal hydride materials include the AB₅ or AB₂ structure types where the “ABₓ” designation refers to the ratio of A elements and B elements. For the AB₅ type, A may be a combination of La, Ce, Pr and Nd, and, for the AB₂ type, A may be Ti, Zr or a combination of Ti and Zr. For both structure types, B may be a combination of Ni, Mn, Co, Al and Fe.

Referring further to FIG. 2, the housing 22 (e.g., case, container, casing, etc.) is shown including a base 23 and a lid 24 according to an exemplary embodiment. A seal 25 (e.g., a molded nylon sealing gasket, etc.) is formed/disposed generally between the base 23 (e.g., can, etc.) and the lid 24 (e.g., cap, cover, top, etc.) to help maintain the relative positions of the base 23 and the lid 24. The seal 25 also helps prevent undesirable contacts (e.g., causing a short circuit) and/or leakage. The lid 24 includes one or more holes 26 at a first portion 27 of the housing 22 generally opposite a second portion 28. The metal electrode 12 is shown disposed within housing 22 at or proximate to the second portion 28. The air electrode 14 is shown disposed at or proximate to the first portion 27, and spaced a distance from the metal electrode 12. The holes 26 (e.g., apertures, openings, slots, recesses, etc.) provide for interaction between the air electrode 14 and the oxygen in the surrounding atmosphere (e.g., air), with the oxygen distribution layer 16 allowing for relatively even distribution of the oxygen to the air electrode 14. The surrounding atmosphere may be ambient air or one or more air flows may be directed into or across the holes 26. The housing may have any number of shapes and/or configurations according to other exemplary embodiments. Any number of holes having any of a variety of shapes, sizes, and/or configurations may be utilized according to other exemplary embodiments.

The separator 20 is a thin, porous, film or membrane formed of a polymeric material and disposed substantially between the metal electrode 12 and the air electrode 14 according to an exemplary embodiment. The separator 20 is configured to prevent short circuiting of the battery 10. In some exemplary embodiments, the separator 20 includes or is made of polypropylene or polyethylene that has been treated to develop hydrophilic pores that are configured to fill with the electrolyte 18. In other exemplary embodiments, the separator may be made of any material configured to prevent short circuiting of the battery 10 and/or that includes hydrophilic pores.

The electrolyte 18 is shown disposed substantially between the metal electrode 12 and the air electrode 14 according to an exemplary embodiment. The electrolyte 18 (e.g., potassium hydroxide (“KOH”) or other hydroxyl ion-conducting media) is not consumed by the electrochemical reaction within the battery 10, but, rather, is configured to provide for the transport of hydroxyl ions (“OH⁻”) from the air electrode 14 to the metal electrode 12 during discharge, and, where the battery 10 is a secondary system, to provide for transport of hydroxyl ions from the metal electrode 12 to the air electrode 14 during charge. The electrolyte 18 is disposed within some of the pores of the metal electrode 12 and some of the pores of the air electrode 14. According to other exemplary embodiments, the distribution and location of the electrolyte may vary (e.g., the electrolyte may be disposed in the pores of the metal electrode and to a lesser degree within the pores of the air electrode, etc.).

According to an exemplary embodiment, the electrolyte 18 may optionally include an ionic liquid. The electrolyte 18 is configured to be relatively highly ionically conductive to provide for high reaction rates for the oxygen reduction/evolution and the metal oxidation/reduction reactions. High reaction rates help the battery 10 achieve a desired current density. The electrolyte 18 is further configured to have a relatively low vapor pressure point. The low vapor pressure point means that the electrolyte 18 has a relatively low evaporation rate, which helps to prevent (e.g., resist, slow, etc.) drying out of the electrolyte 18. By preventing the drying out of the electrolyte 18, increased ohmic resistance is avoided. Increased ohmic resistance in a battery generally results in a loss in the power density and a decrease in the efficiency of the battery. The electrolyte 18 may further be configured to stabilize the three phase boundary within the air electrode. The electrolyte 18 may further be configured to provide for more uniform depositions and a different reaction mechanism due to its effect on the charge and discharge reactions (e.g., improving the discharge properties of the battery). According to one exemplary embodiment, the ionic liquid of the electrolyte 18 may be further tailored to provide for low solubility of CO₂ (e.g., by combining the electrolyte with other materials and/or additives, etc.). In some exemplary embodiments, the ionic liquids are configured to be stable and/or be soluble in OH⁻ solutions. In some exemplary embodiments, the ionic liquids are configured to dissolve oxygen. In some exemplary embodiments, the ionic liquids are hydroscopic and can take water from the environment.

According to an exemplary embodiment, the electrolyte 18 is an alkaline electrolyte used to maintain high ionic conductivity between the metal electrode and the air electrode. According to other exemplary embodiments, the electrolyte may be any electrolyte that has high ionic conductivity and/or high reaction rates for the oxygen reduction/evolution and the metal oxidation/reduction (e.g., NaOH, LiOH, etc.). According to still other embodiments, the electrolyte may include salt water or others salt-based solutions that give sufficient conductivity for the targeted applications (e.g., for marine/military applications, etc.).

According to an exemplary embodiment, the metal electrode and the electrolyte are combined (e.g., mixed, stirred, etc.). The combination of the metal electrode and the electrolyte may form a paste, powder, pellets, slurry, etc.

The air electrode 14 includes one or more layers with different properties and a current collector 39 (e.g., a metal mesh, which also helps to stabilize the air electrode). In some exemplary embodiments, a plurality of air electrodes may be used for a single battery. In some of these exemplary embodiments, at least two of the air electrodes have different layering schemes and/or compositions. In other exemplary embodiments, the current collector is other than a metal mesh current collector (e.g., a foam current collector).

Referring further to FIG. 2, the air electrode 14 includes a gas diffusion layer 30 (sometimes abbreviated “GDL”) and an active layer 32 (sometimes abbreviated “AL”) according to an exemplary embodiment.

The gas diffusion layer 30 is shown disposed proximate to the holes 26 in the second portion 28 of the housing 22, substantially between the active layer 32 and the housing 22. The gas diffusion layer 30 includes a plurality of pores 33 according to an exemplary embodiment. The gas diffusion layer 30 is configured to be porous and hydrophobic, allowing gas to flow through the pores while acting as a barrier to prevent liquid flow. In some exemplary embodiments, both the oxygen reduction and evolution reactions take place in one or more air electrode layers closely bonded to this layer.

The active layer 32 is disposed substantially between the metal electrode 12 and the holes 26 in the second portion 28 of the housing 22 according to an exemplary embodiment. The active layer 32 has a double pore structure that includes both hydrophobic pores 34 and hydrophilic pores 36. The hydrophobic pores help achieve high rates of oxygen diffusion, while the hydrophilic pores 36 allow for sufficient electrolyte penetration into the reaction zone for the oxygen reaction (e.g., by capillary forces). According to other exemplary embodiments, the hydrophilic pores may be disposed in a layer separate from the active layer, e.g., an oxygen evolution layer (sometimes abbreviated “OEL”). Further, other layers or materials may be included in/on or coupled to the air electrode. Further, other layers may be included in/on or coupled to the air electrode, such as a gas selective membrane.

The air electrode 14 may include a combination of pore forming materials. In some exemplary embodiments, the hydrophilic pores of the air electrode are configured to provide a support material for a catalyst or a combination of catalysts (e.g., by helping anchor the catalyst to the reaction site material) (e.g., cobalt on carbon, silver on carbon, etc.). According to one exemplary embodiment, the pore forming material includes activated carbon or graphite (e.g., having a BET surface area of more than 100 m²·g⁻¹). According to other exemplary embodiments, pore forming materials such as high surface area ceramics or other materials may be used. More generally, using support materials (or pore forming materials) that are not carbon-based avoids CO₂ formation by those support materials when charging at high voltages (e.g., greater than 2V). One example is the use of high surface area silver (Ag); the silver can be Raney Ag, where the high surface area is obtained by leaching out alloying element from a silver alloy (e.g., Ag—Zn alloy). According to still other exemplary embodiments, any material that is stable in alkaline solutions, that is conductive, and that can form a pore structure configured to allow for electrolyte and oxygen penetration, may be used as the pore forming material for the air electrode. According to an exemplary embodiment, the air electrode internal structures may be used to manage humidity and CO₂.

In the exemplary embodiment shown, the air electrode 14 further includes a binding agent or combination of binding agents 40, a catalyst or a combination of catalysts 42, and/or other additives (e.g., ceramic materials, high surface area metals or alloys stable in alkaline media, etc.). The binding agents 40 are shown included in both the active layer 32 and the gas diffusion layer 30. The catalysts 42 are shown included in the active layer 32. In other exemplary embodiments, the binding agents, the catalysts, and/or the other additives may be included in any, none, or all of the layers of the air electrode. In other exemplary embodiments the air electrode may not contain one or more of a binding agent or combinations of binding agents, a catalyst or a combination of catalysts, and/or other additives.

The binding agents 40 provide for increased mechanical strength of air electrode 14, while providing for maintenance of relatively high diffusion rates of oxygen (e.g., comparable to more traditional air electrodes that typically use polytetrafluoroethylene (“PTFE”)). The binding agents 40 may also cause pores in the air electrode 14 to become hydrophobic. According to one exemplary embodiment, the binders include PTFE in combination with other binders. According to other exemplary embodiments, other polymeric materials may also be used (e.g., polyethylene (“PE”), polypropylene (“PP”), thermoplastics such as polybutylene terephthalate or polyamides, polyvinylidene fluoride, silicone-based elastomers such as polydimethylsiloxane, or rubber materials such as ethylene propylene, and/or combinations thereof).

According to an exemplary embodiment, the binding agents 40 provide mechanical strength sufficient to allow the air electrode 14 to be formed in a number of manners, including, but not limited to, one or a combination of extrusion, stamping, pressing, utilizing hot plates, calendering, etc.

The inventors have unexpectedly determined that, when used as binding agents, PE and PP provide improved mechanical strength of the air electrode. This improved mechanical strength also facilitates formation of the air electrode 14 into any of a variety of shapes (e.g., a tubular shape, a shape to accommodate or correspond to the shape of a housing, etc.). The ability to form the air electrode into any of a variety of shapes may allow for the use of metal-air batteries in applications such as Bluetooth headsets, digital cameras, and other applications for which cylindrical batteries are used or required (e.g., size AA batteries, size AAA batteries, size D batteries), etc. More generally, the use of PE and/or PP also allows for improved/new electrode formation methods, shapes, and applications for metal-air batteries as discussed in more detail below. According to other exemplary embodiments, any plastic material having a melting point lower than PTFE (e.g., below 350° C.) may provide benefits similar to those of PE and PP when used as a binding agent.

The catalysts 42 are configured to improve the reaction rate of the oxygen reaction. According to some exemplary embodiments, catalytically active metals or oxygen-containing metal salts are used (e.g., Pt, Pd, Ag, Co, Fe, MnO₂, KMnO₄, MnSO₄, SnO₂, Fe₂O₃, CoO, Co₃O₄, etc.). According to other exemplary embodiments, a combination of more than one catalytically active material may be used. According to some exemplary embodiments, the catalysts 42 may include recombination catalysts, which the inventors have unexpectedly determined have desirable hydrogen consuming/inhibiting abilities.

In an exemplary embodiment, the battery 10 is a secondary battery (e.g., rechargeable) and the air electrode 14 is a bifunctional air electrode. In this embodiment, additional catalysts or catalyst combinations capable of evolving oxygen may be used in addition to the catalysts and/or combinations of catalysts described above. According to some exemplary embodiments, catalysts may include, but are not limited to, WC, TiC, CoWO₄, FeWO₄, NiS, WS₂, La₂O₃, Ag₂O, Ag, spinels (i.e., a group of oxides of general formula AB₂O₄, where A represents a divalent metal ion such as magnesium, iron, nickel, manganese and/or zinc and B represents trivalent metal ions such as aluminum, iron, chromium and/or manganese) and perovskites (i.e., a group of oxides of general formula AXO₃, where A is a divalent metal ion such as cerium, calcium, sodium, strontium, lead and/or various rare earth metals, and X is a tetrahedral metal ion such as titanium, niobium and/or iron where all members of this group have the same basic structure with the XO₃ atoms forming a framework of interconnected octahedrons). According to other exemplary embodiments, the battery 10 may be a primary battery (e.g., single use, disposable, etc.).

Referring further to FIG. 2, the current collector 39 is disposed between the gas diffusion layer 30 and the active layer 32 of the air electrode 14 according to an exemplary embodiment. According to another exemplary embodiment, the current collector may be disposed on the active layer (e.g., when a non-conductive layer or no gas diffusion layer is included in the air electrode). The current collector 39 may be formed of any suitable electrically-conductive material.

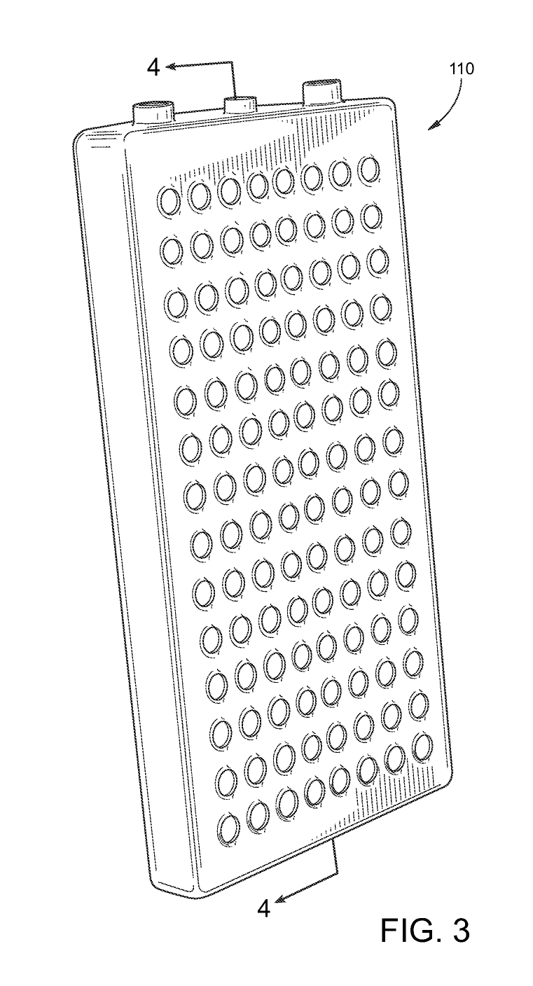

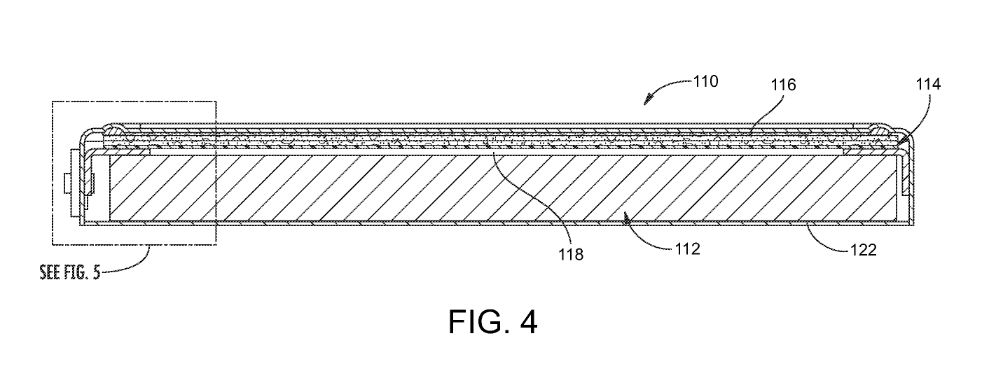

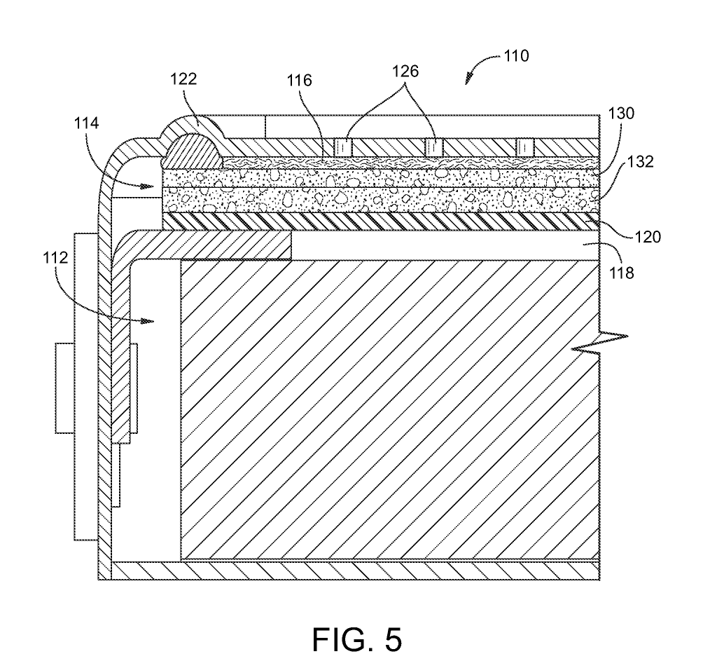

Although FIGS. 1-2 have been described in the context of a button or coin cell type battery, it should be noted that other configurations are also possible. For example, referring to FIGS. 3-5, a prismatic metal-air (e.g., zinc-air) battery 110 is shown according to an exemplary embodiment. FIG. 4 shows a cross-sectional view of the battery 110, and FIG. 5 shows a detail view of one end of the battery 110 taken across line 5-5 in FIG. 4. The battery 110 includes a housing 122, a metal electrode 112 running along the length of the cell, an air electrode 114 (which includes a gas diffusion layer 130 and an active layer 132, along with a current collector provided therein similar to the current collector 39 described above (not shown)), an electrolyte 118 provided in the space between the metal electrode 112 and the air electrode 114, and a separator 120 between the electrolyte 118 and the air electrode 114. An oxygen distribution layer 116 (similar to that described with respect to the oxygen distribution layer 16 for the coin cell embodiment described above with respect to FIG. 2) may optionally be provided between the air electrode 114 and the housing 122. The upper portion of the housing 122 contains holes 126 (e.g., slots, apertures, etc.) for air to enter the battery 110.

The air electrode 114 may be secured (e.g., by gluing, welding (e.g., ultrasonic welding, hot stamping, etc.), or the like) to the lid of the housing to prevent leakage. The gas diffusion layer side of the air electrode faces the holes 126 in the battery housing 122, and the oxygen distribution layer 116 is positioned substantially between the gas diffusion layer and the holes 126 in the housing 122. The battery 110 is filled with a metal (e.g., zinc) paste. Current collectors for the air electrode and the metal electrode may be attached using contact pins by resistance welding, laser welding, or other methods known in the art and shielded (e.g., with glue) to prevent gassing in the cell. The housing is then closed off (other than the air holes) (e.g., by ultrasonic welding).

The battery 110 provides for a commercially viable prismatic battery that may be used in numerous applications wherein prismatic batteries are or may be used because battery 110 provides, in addition to a high current density, a lifetime in that is sufficient and/or desirable for these applications (e.g., cell phones, cameras, MP3 players, portable electronic devices, etc.).

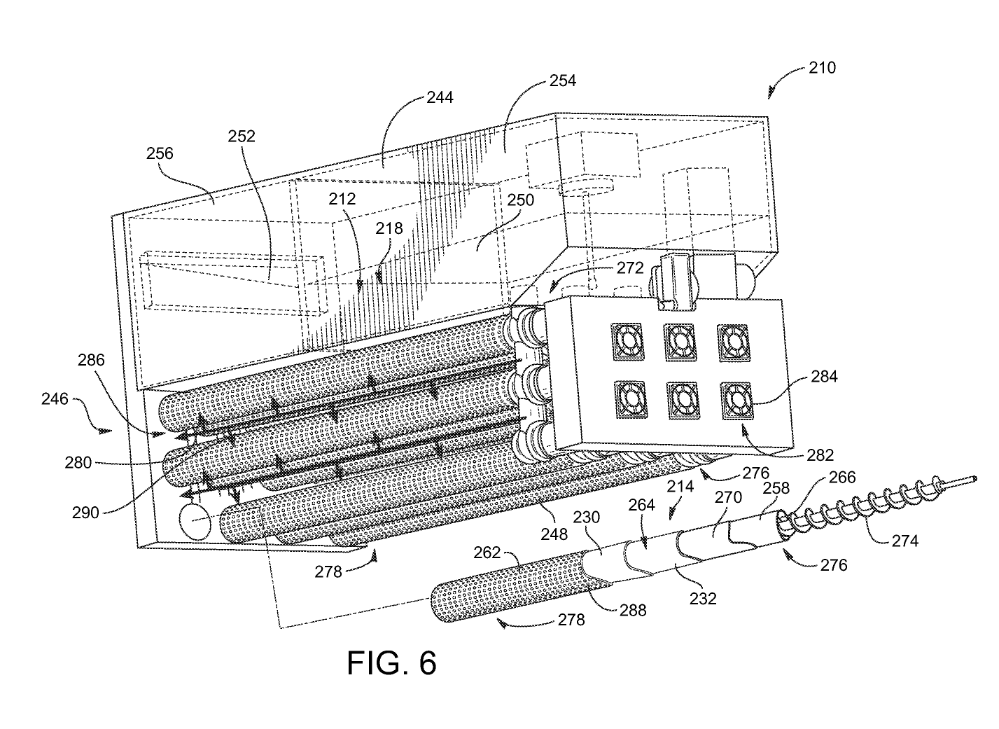

FIG. 6 illustrates an exemplary embodiment of a flow battery 210 similar to those disclosed in International Application PCT/US2010/040445 and corresponding U.S. patent application Ser. No. 12/826,383, each filed Jun. 29, 2010, the entire disclosures of which are incorporated herein by reference.

Referring to FIG. 6, a metal-air flow battery shown as a zinc-air flow battery 210 is shown according to an exemplary embodiment. The term “flow battery” is intended to refer to a battery system in which reactants are transported into and out of the battery. For a metal-air flow battery system, this implies that the metal anode material and the electrolyte are introduced (e.g., pumped) into the battery and a metal oxide is removed from or taken out of the battery system. Like a fuel cell, the flow battery system requires a flow of reactants through the system during use.

The zinc-air flow battery 210 is shown as a closed loop system including a zinc electrode 212, an electrolyte 218, one or more storage devices shown as tank or chamber 244, and a reactor 246 having one or more reaction tubes 248, each of the reaction tubes 248 including an air electrode 214 (which, like the air electrodes described above, includes a gas diffusion layer and an active layer).

The zinc electrode 212 is combined with the electrolyte 218 to form a zinc paste 250, which serves as a reactant for the zinc-air flow battery 210 according to an exemplary embodiment. The reactant (e.g., active material, etc.) is configured to be transported (e.g., fed, pumped, pushed, forced, etc.) into and out of the reactor 246. When the zinc-air flow battery 210 is discharging, the zinc paste 250 is transported into the reactor 246 and through the reaction tubes 248 and a zinc oxide paste 252 is transported out of the reactor 246 after the zinc paste 250 reacts with the hydroxyl ions produced when the air electrode 214 reacts with oxygen from the air. When the zinc-air flow battery 210 is charging, the zinc oxide paste 252 is transported into the reactor 246 and through the reaction tubes 248 and the zinc paste 250 is transported out of the reactor 246 after the hydroxyl ions are converted back to oxygen. The pastes 250, 252 are stored in the tank 244 before and after being transported through the reactor 246, the zinc paste 250 being stored in a first cavity 254 of the tank 244 and the zinc oxide paste 252 being stored in a second cavity 256 of the tank 244. According to another exemplary embodiment, the tank 244 includes only a single cavity, and the zinc oxide paste is stored in the single cavity.

As discussed above, the reaction tubes 246 each include an air electrode 214 disposed between at least two protective layers. FIG. 6 illustrates one of the reaction tubes 248 of the zinc-air flow battery 210 in more detail, exploded from the zinc-air flow battery 210 according to an exemplary embodiment. The reaction tube 248 is shown having a layered configuration that includes an inner tube or base 258, a separator 270, the air electrode 214 (including a gas diffusion layer 230 and an active layer 232), and an outer tube or protective casing 262 according to an exemplary embodiment. The base 258 is shown as the innermost layer of the reaction tube 246, the protective casing 262 is shown as the outmost layer of the reaction tube 246, and the other layers are shown disposed substantially between and concentric with the base 258 and the protective casing 262.

According to the exemplary embodiment shown, the composition of air electrodes 214 enables production of tubular air electrodes according to an exemplary embodiment. The air electrode 214 includes a plurality of binders 264. The binders 264 provide for increased mechanical strength of the air electrode 214, while providing for maintenance of relatively high diffusion rates of oxygen (e.g., comparable to more traditional air electrodes). The binders 264 may provide sufficient mechanical strength to enable the air electrode 214 to be formed in a number of manners, including, but not limited to, one or a combination of injection molding, extrusion (e.g., screw extrusion, slot die extrusion, etc.), stamping, pressing, utilizing hot plates, calendaring, etc. This improved mechanical strength may also enable air electrode 214 to be formed into any of a variety of shapes (e.g., tubular, etc.).

The tubular configuration of the reaction tubes 246, and, correspondingly, the air electrodes 214, makes the air electrodes 214 relatively easy to assemble without leakage. The tubular configuration in conjunction with the conductive gas diffusion layer permits for the current collectors for the air electrodes 214 to be on the outside of the reaction tubes 246, substantially preventing any leakage from the air electrode current collector. Further, the tubular configuration permits for the current collectors for zinc electrodes 212 to be integrated substantially within reaction tubes 246, eliminating contact pin leakage.

In addition, the tubular configuration of air electrodes a 214 provides improved resistance to pressure, erosion (e.g., during transport of zinc paste 250 and zinc oxide paste 252, etc.), and flooding. For example, the tubular configuration of the air electrode permits zinc paste to flow through a passage defined thereby with less friction than if the air electrode were configured as a flat plate, causing relatively less erosion therewithin. Also, the cylindrical reaction tubes 246 having a layered configuration permits for incorporation of elements/layers providing mechanical stability and helping to provide improved pressure resistance.

During discharge of the zinc-air flow battery 210, the zinc paste 250 is fed from the tank 244 through a zinc inlet/outlet and distributed amongst the reaction tubes 246 by a feed system 272. According to the exemplary embodiment shown, the feed system 272 includes a plurality of archimedean screws 274. The screws 274 rotate in a first direction, transporting the zinc paste 250 from proximate the first end portion 276 toward the second end portion 278 of each reaction tube 246. An air flow 280 is directed by an air flow system 282, shown including fans 284, through a plurality of air flow channels 286 defined between the reaction tubes 246. The air flow 280 is at least partially received in the reaction tubes 246 through a plurality of openings 288 in the protective casing 262 and toward the passage 266, as shown by a plurality of air flow paths 290. Oxygen from the air flow 280 is converted to hydroxyl ions in the air electrode 214; this reaction generally involves a reduction of oxygen and consumption of electrons to produce the hydroxyl ions. The hydroxyl ions then migrate toward the zinc electrode 212 in the zinc paste 250 within the passages 266 of the reaction tubes 246. The hydroxyl ions cause the zinc to oxidize, liberating electrons and providing power.

As a result of its interaction with the hydroxyl ions, the zinc paste 250 is converted to the zinc oxide paste 252 within the reaction tubes 246 and releases electrons. As the screws 274 continue to rotate in the first direction, the zinc oxide paste 252 continues to be transported toward the second end portion 278. The zinc oxide paste 252 is eventually transported from reaction tubes 246 through a zinc oxide inlet/outlet and deposited in the second cavity 256 of the tank 244 (or, where only one cavity is provided, into the cavity of the tank).

As discussed above, the zinc-air flow battery 210 is rechargeable. During charging, the zinc oxide paste 252 is converted or regenerated back to zinc paste 250. The zinc oxide paste 252 is fed from the tank 244 and distributed amongst the reaction tubes 246 by the feed system 272. The screws 274 rotate in the second direction (i.e., opposite to the direction they rotate during discharging), transporting the zinc oxide paste 252 from proximate the second end portion 278 toward the first end portion 276 of each reaction tube 246. The zinc oxide paste 252 is reduced to form the zinc paste 250 as electrons are consumed and stored. Hydroxyl ions are converted to oxygen in the air electrodes 214, adding oxygen to the air flow 280. This oxygen flows from the reaction tubes 246 through the openings 288 in the protective casing 262 outward from proximate the passage 266, as shown by the air flow paths 290.

The composition, structure, and manufacture of an air electrode for use with the batteries illustrated in FIGS. 1-6 will now be discussed. For ease of reference, the following description will be presented with reference to the air electrode 14 shown and described in FIG. 2, although it should be understood by those reviewing this disclosure that the compositions, structures, and processing methods described below may be used with any of the air electrodes described above (e.g., for button or coin cell batteries, prismatic batteries, flow batteries) and with any air electrodes for metal-air batteries of other configurations (e.g., cylindrical batteries such as AA, AAA, C, and D cells or other types of cylindrical batteries, etc.).

For purposes of this discussion, an air electrode may considered to include one or more primary layers (e.g., a gas diffusion layer, an active layer, an oxygen evolution layer, etc.). Each primary layer may include one or more sublayers. It should be noted that the term “layer” as used in the discussion below may be used to refer to a primary layer or to a sublayer of a primary layer.

Metal-air batteries having improved performance and/or that are viable in new applications can be obtained by utilizing improved air electrodes and/or other improved metal-air battery components.

The inventors have developed new and/or improved battery constructions and methods of production to achieve improved air electrodes and other metal-air battery components.

In addition to improving air electrode and metal-air battery performance, improved air electrodes can also provide cost savings (e.g., by using more cost-effective production methods, by using less expensive materials, etc.).

By utilizing processes or techniques that provide a relatively high level of control over the layering scheme and/or construction of an air electrode, improved air electrodes can be produced.

An air electrode may include one or more primary layers (e.g., a gas diffusion layer, an active layer, an oxygen evolution layer, etc.). Each primary layer may include one or more sublayers. It should be noted that the term “layer” will be used to refer generally to a primary layer or a sublayer.

According to an exemplary embodiment, an air electrode is formed in a multi-step process. First, the desired component elements of each layer are mixed together. The pore forming materials, the catalysts, the binding materials and/or other additives are mixed under the influence of mechanical, thermal, or mechanical and thermal energy. It is desirable that the materials be well distributed. If the mixture contains a hydrophobic binding agent, then this binding agent forms a three dimensional network connecting the powders into an agglomerate.

Second, each mixture is formed into a layer (which may be a primary layer or a sublayer of a primary layer), as will be described in greater detail below. For example, a gas diffusion layer may be produced using an injection molding or screw extrusion process (or another type of process, such as forming the material into a brick and calendering it to a desired thickness, using a slot die extrusion process, forming the layer in a printing, spraying, spin coating, dip coating, or other suitable process, etc.), and the active layer may be produced using a separate injection molding or screw extrusion process (or another type of process, such as forming the material into a brick and calendering it to a desired thickness, using a slot die extrusion process, forming the layer in a printing, screening, spraying, or other suitable process, etc.). The processes used to form the different primary layers of the air electrode (and/or the different sublayers of any of the primary layers if such sublayers are present) may be the same or may differ. For example, a screw extrusion process may be used to form the gas diffusion layer and an injection molding or slot die process may be used to form the active layer. Other combinations are possible according to other exemplary embodiments.

Third, two or more of the layers (e.g., a gas diffusion layer and an active layer) are coupled together. According to an exemplary embodiment, the layers may be joined using heat and/or pressure (e.g., by calendering and/or pressing). According to another exemplary embodiment, a first layer may be formed and a second layer may be formed directly onto the first layer (e.g., using a printing or spraying process, etc.), in which case the second and third steps are effectively combined into a single step.

Fourth, the current collector is coupled (e.g., pressed or calendered) into the combined layers (e.g., into the active layer, into the gas diffusion layer, between the active layer and the gas diffusion layer, etc.). According to an exemplary embodiment, the current collector is sandwiched between the active layer and the gas diffusion layer, and may be joined to both layers in conjunction with the third step described above in which the active layer and the gas diffusion layer are joined. According to another exemplary embodiment, the current collector may be coupled to the gas diffusion layer (e.g., by pressing or calendering) and the active layer may subsequently be applied over the current collector (e.g., by pressing a calendering the active layer to the current collector or by forming layers directly over the current collector using a process such as printing, spraying, spin coating, dip coating, etc.).

According to an exemplary embodiment, a dry mixing process is utilized in the first step to form the layers of the air electrode. In a dry mixing process, all of the ingredients of a layer are mixed together in the form of dry powders. In a case where carbon itself does not form the pore structure, an additional pore forming aid such as ammonium bicarbonate may be used to create the gas diffusion layer and/or the oxygen evolution layer.

According to other exemplary embodiments, a wet mixing process may instead be utilized. In a wet mixing process, one or more solvents are added at the beginning or during the mixing process, or, alternatively, one or more ingredients may be used in the form of a dispersion or suspension. The solvent(s) are typically subsequently removed (e.g., directly after the mixing process or in a later state of the production process) (e.g., by using a heating/drying process). According to an exemplary embodiment, a wet process utilizes one or more binders that are suspended in water or another solvent and a pore forming aid or a carbon material in the gas diffusion layer is used to form pores.

According to still another exemplary embodiment, the various individual layers may be made using different methods. For example, some of the layers may be produced using a dry mixing process, while others may be produced using a wet process. According to yet still another exemplary embodiment, it is possible to combine both dry and wet processes for the different layers and the production may be performed in a continuous production line according to PCT publication WO 2005/004260, the disclosure of which is incorporated herein by reference.

An oxygen evolution layer may be included in the air electrode. According to an exemplary embodiment, the oxygen evolution layer may include 2 to 15 percent binding agent by weight and 25 to 65 percent catalyst(s) by weight. The remainder of the oxygen evolution layer may include a high surface area carbon and/or graphite material and possibly some other additives.

Referring now to the exemplary embodiments shown in FIGS. 7-9, a multi-layer air electrode 810 including a gas diffusion layer 812 having a plurality of sublayers 814 and an active layer 816 having a plurality of sublayers 818 is shown according to an exemplary embodiment. Using one or more of the multi-layer production processes described below (e.g., screen printing, spray printing, spin coating, etc.), each sublayer (or portion thereof) may be formed thinner than layers that may be formed using conventional air electrode production processes (e.g., using calendaring and lamination), which typically have thicknesses greater than 100 micrometers (as defined along the z-direction indicated in FIG. 7). Sublayers formed using the below-described printing and coating processes may be thin films (e.g., having thicknesses less than 100 micrometers, etc.).

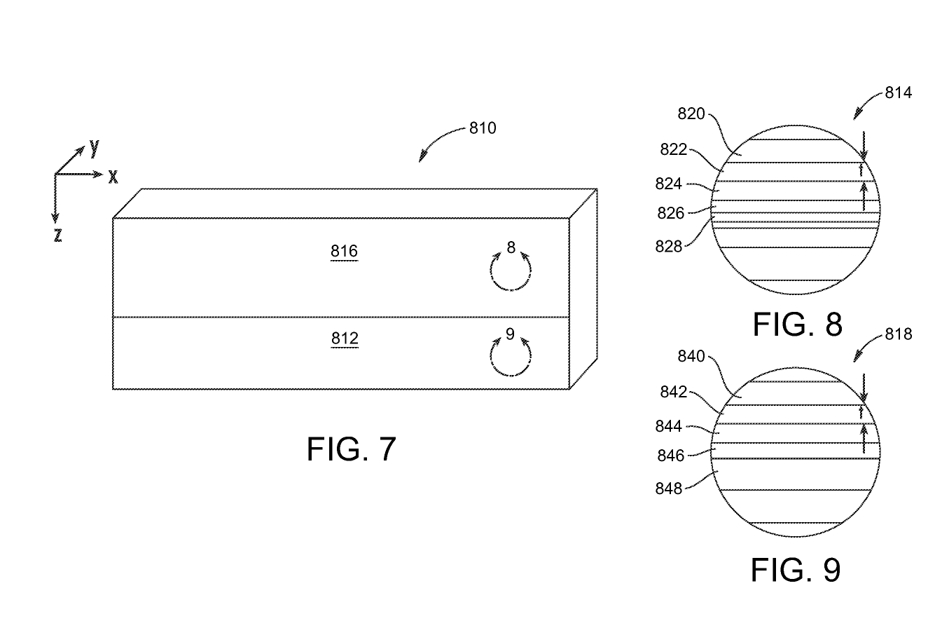

Referring to FIG. 8, a sectional view of the plurality of sublayers 814 of the gas diffusion layer 812 is shown in more detail including a first sublayer 820, a second sublayer 822, a third sublayer 824, a fourth sublayer 826, and a fifth sublayer 828, etc. according to an exemplary embodiment. According to one exemplary embodiment, all of the sublayers 814 of the gas diffusion layer 812 are thin films. According to other exemplary embodiments, less than all of the sublayers are thin films (e.g., one of the sublayers is a thin film, all but one of the sublayers is a thin film, four of the sublayers are thin films, etc.). According to some exemplary embodiments, two or more adjacent sublayers 820, 822, 824, 826, and/or 828 may be electrically isolated from one another (e.g., through the use of a separation material).

Referring to FIG. 9, a sectional view of the plurality of sublayers 818 of the active layer 816 is shown in more detail including a first sublayer 840, a second sublayer 842, a third sublayer 844, a fourth sublayer 846, and a fifth sublayer 848, etc. according to an exemplary embodiment. According to one exemplary embodiment, all of the sublayers 818 of the active layer 816 are thin films. According to other exemplary embodiments, less than all of the sublayers are thin films (e.g., one of the sublayers is a thin film, all but one of the sublayers is a thin film, four of the sublayers are thin films, etc.).

Referring to FIGS. 8 and 9, each layer of the plurality of sublayers 814 of the gas diffusion layer 812 and the plurality of sublayers 818 of the active layer 816 is shown having a different thickness “t,” defined generally along the stacking axis (shown as the z-axis in FIG. 7) of the air electrode (or portion thereof). According to some exemplary embodiments, the thicknesses of some layers may be the same while others differ. According to other exemplary embodiments, the thicknesses of the layers may all be the same, may vary at certain locations of a sublayer, etc. According to other exemplary embodiments, the thicknesses of the sublayers in a primary layer or a portion thereof may get progressively larger or smaller. The thickness of a given sublayer can depend on the composition of that layer, the position of that layer in the air electrode, the layers adjacent to that layer, the function of that layer, etc.

Each sublayer is formed by applying coating material (e.g., solution, suspension, ink, etc.) to a substrate. The substrate may be a flat surface, a curved surface, or an irregularly shaped surface. According to one exemplary embodiment, the substrate is a previously formed layer of the air electrode (e.g., the gas diffusion layer, the active layer, a sublayer of the gas diffusion layer or the active layer, etc.). According to another exemplary embodiment, the substrate may be another metal-air battery component (e.g., a housing). According another exemplary embodiment, the substrate is a glass plate. According to another exemplary embodiment, the substrate is a plastic film. According to another exemplary embodiment, the substrate is a metallic film. According to some exemplary embodiments, the substrate is porous and intended to facilitate removal of the substrate without substantially damaging the layers formed on it. According to some exemplary embodiments, the substrate is non-porous. According to other exemplary embodiments, the substrate may be any support surface suitable for supporting a sublayer during formation.

According to an exemplary embodiment, the coating material is a liquid. The liquid includes particles to be distributed onto the substrate. According to other exemplary embodiments, the coating material may also include, but is not limited to, a slurry or a paste.

It should be noted that a single sublayer may be formed using a single coating material application or a plurality of coating material applications, as discussed in more detail below. The coating material is generally retained (e.g., stored, held, deposited, etc.) in one or more reservoirs (e.g., receptacles, bags, pouches, cartridges, reserves, repositories, containers, etc.) and then applied to one or more surfaces of a substrate. Each coating material used to form a sublayer may be applied (e.g., distributed, dispersed, delivered, disseminated, dispensed, provided, served, etc.) from a single reservoir or from multiple reservoirs. Wherein multiple reservoirs are used to apply a sublayer, the reservoirs may each contain the same coating material components, may each contain different coating material components, or some reservoirs may contain the same coating material components while others contain different coating material components. It should also be noted that a single sublayer may include two or more portions each having a different composition (i.e., the composition within the sublayer may vary, for example, in the x-y plane indicated in FIG. 7).

The composition of each sublayer may be varied by changing (e.g., adjusting, substituting, replacing, altering, modifying, etc.) the composition of the coating material applied to form the sublayer. The composition of each sublayer may also be varied by removal of material elements in the original coating material after application (e.g., by evaporation, by leaching, etc.) and/or by changing the sequence in which a plurality of coating materials are applied to form the sublayer.

It should be noted that the properties of the coating materials used to form the sublayers may vary depending on the type of printing or coating process used and/or the desired thickness of the resultant sublayer. For example, the inclusion and/or amount of a water-based suspension including additives to prevent segregation of the deposited powder materials in the coating material may be varied. In another example, the temperature and/or length of time heat is applied to a coating material after it has been applied to a substrate may be varied.

Referring to FIGS. 8 and 9, the composition of each sublayer may vary according to an exemplary embodiment. In another exemplary embodiment, the composition of each sublayer is substantially similar. In another exemplary embodiment, the compositions of the sublayers may alternate. For example, every other sublayer may have the same composition. In some exemplary embodiments, two or more sublayers having substantially similar compositions are grouped together (e.g., are disposed adjacent to one another). In some exemplary embodiments, two or more sublayers having substantially similar compositions are spaced a distance from each other (e.g., not disposed adjacent to one another). In some exemplary embodiments, two or more groupings of sublayers have substantially similar compositions. In some exemplary embodiments, two or more groupings of sublayers have compositions that differ. In some exemplary embodiments, all sublayers are grouped with other sublayers having a substantially similar composition. In some exemplary embodiments, some sublayers are included in groupings of sublayers having substantially similar compositions while others sublayers are not grouped with sublayers having substantially similar compositions. According to still other exemplary embodiments, the composition of the sublayers may be varied in substantially any desirable manner. It should be noted that sublayers having substantially identical compositions may be applied in different manners (e.g., from two reservoirs having the same coating material components, from two reservoirs containing different coating material components which combine to result in the composition of the resultant sublayer, etc.).

The methods developed by the inventors provide more control over air electrode production than conventional air electrode production methods (e.g., mixing processes exhibiting a general lack of control). For example, using conventional air electrode production methods, dry or wet mixtures are used to form an entire primary layer or a relatively large sublayer thereof (e.g., having a thickness greater than 100 micrometers, as discussed above). These mixtures necessarily included a large number (if not all) of the component elements (e.g., materials, particles, etc.) to be included in the formed/finished air electrode layer.

In contrast, the below-described multi-layered air electrode production methods developed by the inventors allows for production of air electrodes including sublayers (or portions thereof) that are thin films (e.g., having a thickness of less than 100 micrometers, as discussed above). Multi-layer air electrode production processes are generally less complex, less expensive, and less time consuming that conventional air electrode production processes. These processes also provide numerous other benefits related to cost, complexity, efficiency performance, and applications, which are described in more detail below.

In some embodiments, printing methods (e.g., screen printing, spray printing, etc.) may be used in the production of air electrodes. These printing methods have been successfully utilized to produce a complete air electrode, a primary layer of an air electrode, and one or more sublayers of an air electrode or primary layer. Sublayers produced using printing methods are generally thin films (e.g., having a thickness of approximately 0.5 μm-400 μm). Also, these printing methods can be used to create textured sublayers.

In one embodiment, an air electrode or one or more sublayers thereof may be produced using a screen printing method. Screen printing provides the ability to apply thin sublayers to a substrate and the option to texture these sublayers. Screen printing also provides for a high degree of control over the thickness of each sublayer.

Screen printing methods (a.k.a., silk screening, serigraphy, etc.) generally include forming a sublayer by applying a coating material to a substrate using a screen stencil.

The screen stencil includes a mesh and a coating-blocking material that allows for patterning of the sublayer. The coating-blocking material blocks (covers, overlays, etc.) portions of the mesh to form a stencil. The coating material for the sublayer is applied and moved (e.g., transferred, forced, pumped, etc.) through the portions (e.g., areas, regions, etc.) of the mesh not blocked off by the coating-blocking material (i.e., open portions). According to one exemplary embodiment, a roller or squeegee is moved across the screen stencil, forcing or pumping the coating material past the mesh in the open portions. According to other exemplary embodiments, other devices or methods for moving the coating material through the open portions of the screen stencil may be used.

The mesh is generally a semi-permeable or porous barrier made up of numerous attached (e.g., interconnected, bonded, etc.) or woven strands. The strands may be strands of metal, fiber, and/or other flexible/ductile materials. Generally, the mesh is any material suitable for allowing for transport of a coating material.

The coating-blocking material is intended to prevent the coating material from moving through certain portions of the mesh. The coating-blocking material is typically an impermeable material. The stencil formed by the portions of the screen that are blocked off by the coating-blocking material is a negative of the image to be printed. That is, the open portions of the screen correspond to the locations where the coating material will be applied to the substrate to form the sublayer. Conversely, the portions of the screen blocked off by the coating-blocking material result in “blanks” or blank portions (e.g., apertures, voids, openings, locations where the coating material is not deposited, etc.) in the resultant sublayer. By blanking certain portions of the substrate, textures and/or patterns having desired configurations can be produced.

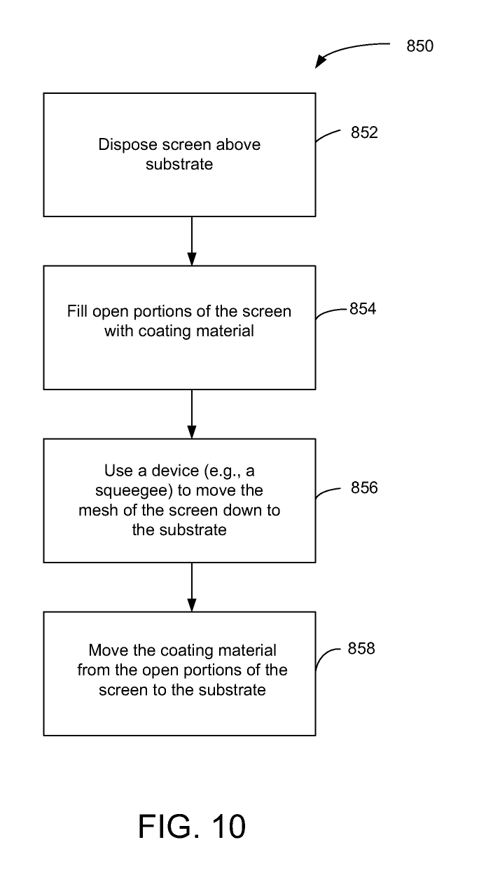

Referring to FIG. 10, a sublayer of an air electrode is formed using a screen printing method 850 according to an exemplary embodiment. A screen is provided and disposed generally above a substrate in a step 852. A fill bar (a.k.a., a floodbar) is used to fill the open portions of the screen with the coating material. The fill bar begins disposed at one end of the screen and behind a reservoir of the coating material. After ensuring the screen is not initially in contact with the substrate, a force is applied to pull the fill bar in order to move the fill bar across the screen, filling the open portions of the screen with coating material in a step 854. This action also causes the fill bar to be moved to an opposing end of the screen. A squeegee or similar device is subsequently used to move the mesh down to the substrate in a step 856 and then moved across the screen (e.g., from one end of the screen to an opposing end of the screen) to move (e.g., pump or squeeze) by capillary action the coating material from the open portions of the screen to the substrate in a step 858. The coating material is moved in a controlled and prescribed amount (i.e., the coating thickness is substantially equal to the thickness of the mesh and or the stencil, and, accordingly, the thickness of the deposited coating can be varied by varying the thickness of the mesh and/or stencil). Typically, as the squeegee is moved across the screen, the tension of the mesh pulls the mesh up away from the substrate (i.e., the mesh snaps-off), leaving the coating material on the substrate surface to form the sublayer. It should be noted that method 850 may be varied depending on the coating composition and/or the position of the sublayer formed in the air electrode. According to other exemplary embodiments, any reservoir suitable for distributing coating material and filling the open portions of a screen may be used in lieu of a fill bar.

According to an exemplary embodiment, a plurality of successive sublayers are produced using a screen printing method. For example, according to one embodiment, a first coating material is screen printed onto a substrate (e.g., a porous or non-porous support surface, as described above) to form a first sublayer of the air electrode, after which a second coating material is screen printed onto the first sublayer to form a second sublayer of the air electrode. A third coating material is then screen printed onto the second sublayer to form a third sublayer of the air electrode. Additional sublayers may continue to be formed using a screen printing process. It should be noted that the screen stencil used for each application of coating material may be varied (and that any desired number of layers may be produced using this method).

According to an exemplary embodiment, a flat-bed screen printing press is utilized during the screen printing processes. According to other exemplary embodiments, a cylinder or rotary screen printing press is utilized. Generally, the type of press utilized depends on the configuration of the air electrode being produced.

According to an exemplary embodiment, the screen printing process or technique is automated. Automation provides for high speed production of air electrodes or layers thereof.

In some embodiments, an air electrode or one or more layers thereof may be produced using a spray printing method (e.g., spray painting, spray coating, etc.). Spray printing provides the ability to apply thin film sublayers of material to a substrate and the option to texture these sublayers. A high degree of control can also be exercised over the thickness of these sublayers. Spray printing also provides the ability to efficiently include gradients of certain material components (e.g., a catalyst, the amount and type of a binder, the support materials, an electrolyte in the form of an OH⁻ conductive polymer, etc.) through the air electrode. This can be accomplished, for example, by gradually adjusting the powder mixture concentrations in the coating material, where the coating material includes powder mixture and solvent components. While gradients can also be produced using a screen printing process, a spray printing process can typically produce a gradient of a material component even more efficiently than a screen printing process.

A spray printing method generally includes application of a coating material to a substrate by spraying a coating material through an atmosphere (e.g., air, argon (Ar), nitrogen (N₂), etc.) onto a substrate. According to one exemplary embodiment, the spray printing method may utilize or be a variant of an ink jet material deposition process. Ink jet-type deposition processes have a number of advantages, including the ability to apply coating materials with great precision.

According to an exemplary embodiment, a spraying device utilized for spray printing air electrode layers includes one or more nozzles and a device or system for spraying the coating material (e.g., compressed gas, etc.). The consistency and texture of the coating can be changed by varying the shape and size of a nozzle and/or one or more of the spray holes thereof.

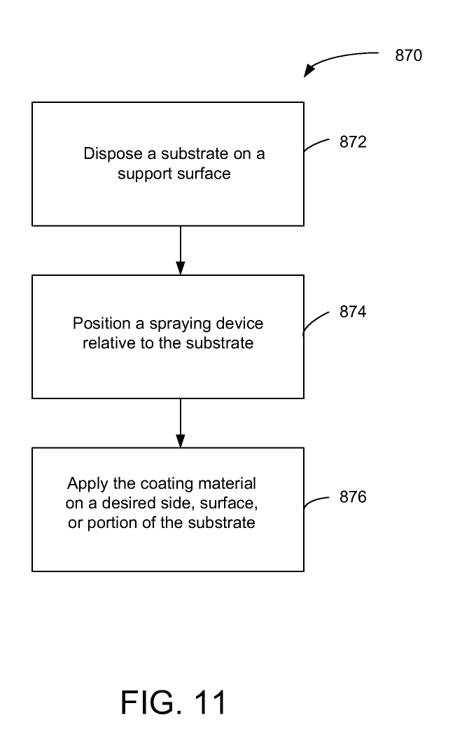

Referring to FIG. 11, a sublayer of an air electrode is formed using a spray printing method 870 according to an exemplary embodiment. The substrate to receive the coating material is disposed on a support surface (e.g., stand, fixture, rollers, etc.) in a step 872. A spraying device is positioned relative to the substrate in a step 874 (e.g., within millimeters or centimeters of the substrate). The coating material is applied onto the desired side, surface, or portion of the substrate in a step 876. The spraying device may be an air gun, an ink cartridge droplet dispenser (e.g., similar to those used in ink jet printing), or any other device suitable for spraying a coating material through an atmosphere toward a substrate to form a layer. The sublayer formed by applying the coating material may be smooth or textured. The texture of the resulting sublayer may be varied by altering the position of the spray device, altering the position of the support surface for the sample, changing or adjusting a nozzle, changing the movement of the spraying device, turning the spraying device on and off, etc. The textures may have a magnitude generally within the range of nanometers to centimeters. The textures may include, but are not limited to, channels, dots or three-dimensional networks, spherical features, cylindrical features, rectangular features, and/or a random distribution of material over a surface.

According to an exemplary embodiment, a plurality of successive sublayers are produced using a spray printing method. For example, according to one exemplary embodiment, a first coating material is spray printed onto a substrate (e.g., a plastic film, a porous film, a metal film or layer, etc.) to form a first sublayer of the air electrode, after which a second coating material is spray printed onto the first sublayer to form a second sublayer of the air electrode. A third coating material is spray printed onto the second sublayer to form a third sublayer of the air electrode using a screen printing method. Additional sublayers may continue to be formed using a spray printing process. It should be noted that the coating composition, thickness, and/or texture may be varied with each application (and that any desired number of layers may be produced using this method).

According to an exemplary embodiment, a piezoelectric ink-jet-type spray printing air electrode production process is used to form a sublayer of an air electrode. A piezoelectric material is included in a coating-material-filled reservoir behind a nozzle. Applying a voltage to the piezoelectric material causes the piezoelectric material to change shape and/or size. The change in the shape and/or size of the piezoelectric material creates a pressure pulse in the coating material, forcing a portion (e.g., droplet, etc.) of the coating material from the nozzle. This process may be continuous, discontinuous, or semi-continuous.

According to an exemplary embodiment, a thermal ink-jet-type spray printing air electrode production process may be used to form a sublayer of an air electrode.

According to an exemplary embodiment, a spray gun is used to form a sublayer in an automated process. The spray gun includes a gun head, which is attached to a mounting block and delivers a stream of the coating. During application of the coating to the substrate, the spray gun may move relative to the substrate, the substrate may move relative to the spray gun, and/or both the substrate and the spray gun may move relative to each other.

In some embodiments, one or more layers of an air electrode may be produced using a spin coating method. Spin coating provides the ability to deposit a substantially uniform layer of material onto a substrate and provides for a high degree of control over the thickness of each sublayer. Spin coating also provides the ability to form sublayers on irregular surface (e.g., cylindrical, star-shaped, etc.). It is believed that this method can also be utilized to include (e.g., add, integrate, layer, etc.) novel materials (e.g., ion selective material, ionic liquids, siloxane-type material, etc. discussed in more details below) into a base structure of an air electrode and/or to include catalyst layers from a solution. It is also believed that the above-described printing methods and variations thereof can be utilized to add novel materials.

Spin coating methods generally include application of a coating material to a smooth substrate. The coating material is typically applied in excess (e.g., an amount greater than needed for the resultant layer). The substrate is then rotated, which causes the coating material to spread across the surface of the substrate, with the excess expelled (e.g., discharged, flung off, cast off, etc.) outward from the edges of the substrate.

The thickness of the resultant layer can be controlled by controlling the rate at which the spin coater (a.k.a., spinner, etc.) is rotated, the composition of the coating material, and/or the concentration of the solution and the solvent. Typically, the greater the length of time that the substrate is rotated, the thinner the resultant layer will be. For example, for a period of time, the coating material will continue to be expelled from the substrate as the substrate is rotated. The substrate may be rotated for only a portion of this period to form a thicker layer or may be rotated for the entire period to form a thinner sublayer. Also, when the solvent of the solution is volatile, it evaporates as the substrate rotates. Further, when the solvent is volatile, rotating the substrate at higher angular speeds typically results in thinner layers.

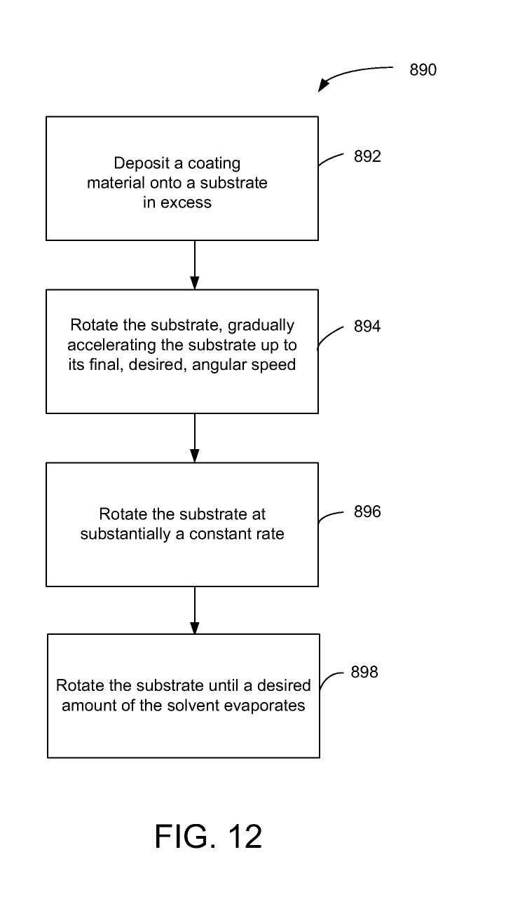

Referring to FIG. 12, a method 890 for producing a spin coated layer of an air electrode 400 includes four steps according to an exemplary embodiment. It should be noted, however, that the steps may be grouped or classified in other manners.

First, a coating material is deposited onto a substrate in excess (i.e., using more than is needed/required to form the desired sublayer) in a step 892. In one exemplary embodiment, the solution is deposited by using a nozzle to pour or spray the solution onto the surface of the substrate. According to other exemplary embodiments, the solution may be deposited in any suitable manner.

Second, the substrate is rotated, gradually accelerating up to its final, desired, angular speed in a step 894.

Third, the substrate is rotated at substantially a constant rate, because fluid viscous forces generally dominate the fluid thinning behavior, in a step 896.

Fourth, the substrate is rotated until a desired amount of the solvent evaporates in a step 898. During this step, evaporation generally dominates the coating thinning behavior

Alternatively, one or more of steps 894, 896, and 898 can be grouped together.

Spin coating allows production of thin film sublayers that are very thin. According to one exemplary embodiment, a layer deposited by spin coating may have a thickness of less than 10 μm. According to other exemplary embodiments, the sublayer thicknesses may be within a range of approximately 400 μm to several mm.

According to an exemplary embodiment, an active layer is spin coated onto a gas diffusion layer. The gas diffusion layer may be formed by any method disclosed herein (e.g., screen printing, spray printing, spin coating, extrusion, injection molding, combinations thereof, etc.). The active layer may be formed during a single, continuous application of coating material using spin coating or from multiple, discontinuous (or semi-continuous) applications of coating materials using spin coating. Alternatively, the gas diffusion layer may be spin coated onto an active layer, the active layer being formed by any method disclosed herein.

According to an exemplary embodiment, a spin coating process may be used to form a single sublayer of an air electrode. According to another exemplary embodiment, a spin coating process may be used to form a plurality of sublayers of an air electrode. According to still another exemplary embodiment, a primary layer of an air electrode can be formed utilizing a single, continuous spin coating process.

According to an exemplary embodiment, a method of producing an air electrode includes spin coating both an active layer and a gas diffusion layer. Both the active layer and the gas diffusion layer are formed by spin coating several sublayers onto a substrate (e.g., the battery housing, a previously applied sublayer, etc.). In one exemplary embodiment, the air electrode production and the battery assembly can be combined into one step/line (i.e., separate lines for air electrode production and assembly are not a requirement). This can provide for improved control of the overall tolerances because one avoids having to sum the standard deviations of the air electrode thicknesses from both parts of the production process. According to some exemplary embodiments, the need for a secondary production process involving the application of heat and/or pressure (e.g., calendaring, lamination, etc.) is eliminated.

According to an exemplary embodiment, a spin coating process is used to apply a selective film on a gas diffusion layer and/or an active layer of an air electrode.

According to an exemplary embodiment, a spin coating process is used to apply a catalyst layer (discussed in more detail below) on an active layer.

In some embodiments, one or more layers of an air electrode may be produced using a dip coating method. Dip coating provides the ability to deposit a relatively thin layer of an air electrode. According to some exemplary embodiments, the dip-coated layer is a thin film.

According to an exemplary embodiment, dip coating a substrate to form a layer involves immersing a substrate in a coating material disposed in a receptacle (e.g., tank, bowl, etc.). The substrate remains in the receptacle for a period of time, providing the coating material an opportunity to form a layer about/on the substrate. Finally, the substrate is withdrawn from the receptacle. Alternatively, the receptacle can be drained of the coating material. Generally, the longer the substrate is disposed in the coating material, the thicker the resultant layer will be.

The above-described air electrode production methods provide numerous benefits related to the production, construction, and utilization of air electrodes and layers thereof, some of which are discussed in more detail below. It should be noted that some of the benefits may overlap in some regards. Also, more than one of the new and/or improved processes or constructions may be utilized in combination to achieve additional benefits.

First, the production methods provide the ability to produce relatively thin (e.g., thin film) sublayers.

As discussed in more detail above, multiple thin film layers can replace a single relatively thick layer formed by a conventional air electrode production process. Accordingly, one or more relatively thick layers of an air electrode formed of one or more relatively thick layers may be replaced by a plurality thin film sublayers. The benefits of replacing relatively thick layers with thin film sublayers will be readily apparent to the reader in view of the discussions below. In some exemplary embodiments, the thin film sublayers replace all of the relatively thick layers of an air electrode, while, in other exemplary embodiments, the thin film sublayers are used in combination with relatively thick layers.

Second, the production methods provide the ability to achieve improved uniformity of the sublayers produced, and, by virtue of the sublayers, the ability to provide for improve uniformity of the air electrode.

By utilizing relatively thin layers to produce an air electrode or a portion thereof, some of the segregation that occurs when materials (e.g., particles, elements, compounds, etc.) of varying densities are mixed or combined in coating material batches intended to be used to form relatively thick layers can be avoided. Typically, relatively thick layers require inclusion of a greater variety of materials than thinner layers, presenting a greater opportunity for segregation (e.g., in production methods wherein one or more primary layers of an air electrode is formed from a single mixture/batch including all materials that will be included in that layer, etc.). The utilization of relatively thin layers allows for some materials (e.g., catalysts, binders, etc.) to be used in some layers, but not others. More generally, the use of relatively thin layers allows for the use of certain materials only where needed and/or in desired quantities/proportions in the air electrode (discussed in more detail throughout this disclosure).

By utilizing relatively thin layers to produce an air electrode or a portion thereof (by virtue of a multi-layer air electrode production method), one can also achieve more consistent mass-produced air electrodes. As mentioned above, each coating material is less likely to experience segregation, both before and after application. Further, a higher level of control may be exercised over the composition of each coating material used during the air electrode production process (e.g., there may not be as much variance in coating composition as there would be in larger batches and/or batches including a larger number of different component elements). Utilizing relatively thin layers also allows one to easily change parameters (e.g., composition, thickness, size, etc.) (e.g., for a layer, for a series of layers, etc.) without having to make significant changes to the production line. Inconsistent production methods can cause a number of problems, including lack of control in the catalyst distribution within the air electrode, thickness variations resulting in leakage and/or cracking, higher scrap rates, etc. All of these problems can be substantially avoided by utilizing thin film sublayers produced using the above-described air electrode production methods.

Third, the production methods may provide the ability to exercise a significantly greater level of control over the amount, type, and/or positioning of certain materials within the air electrode generally along the stacking axis or the z-axis (as shown in FIG. 7).

As discussed above, existing processes to form the air electrode and the primary layers thereof provide minimal control over the amount, type, and/or positioning of certain elements within the air electrode (e.g., because of the mixing process, the thicker layers, etc.). The above-disclosed production processes allow one to form numerous sublayers in the place of what was previously a single layer formed by a conventional, low-control air electrode production process. The composition of each sublayer (e.g., the amount and type of materials therein) can be controlled (e.g., by vary the composition of the coating material used to form each sublayer, etc.). Control over the position of these materials is provided by the ability to determine the order in which the various coating materials are applied and/or the thicknesses of the sublayers formed/produced. Thus, the above-described layering processes provide a high degree of control over the distribution of materials along the axis in which the layers are being stacked (see, e.g., FIG. 7 along the z-axis). According to some exemplary embodiments, the stacking axis corresponds to the direction of air flowing into the housing and/or the OH⁻ ions flowing from the air electrode toward the metal anode.

Controlling the amount, type, and positioning of materials along the stacking axis/z-axis allows for gradients to be created in air electrodes or portions thereof (e.g., a primary layer, a portion of a primary layer, a portion of one primary layer and a portion of another primary layer, etc.). As mentioned above, gradients of certain materials can be achieved, for example, by gradually adjusting the powder mixture concentrations in the coating material, where the coating material includes powder mixture and solvent components. Alternatively, any variation in the coating composition that achieves a progressive increase or decrease of a material moving along the stacking axis/z-axis in the resultant air electrode may be used. In some embodiments, a substantially continuous gradient may be created in a layer by gradually adjusting the concentration of a material during formation of the layer. For example, an amount of an oxygen evolution catalyst in a layer may be altered from a low initial concentration to a high concentration during formation of the layer, creating a concentration gradient throughout the layer.

According to one exemplary embodiment, varying the composition of elements in sublayers can reduce the risk of delamination of the air electrode, especially between the active layer and the gas diffusion layer. According to some exemplary embodiments, the risk is reduced by forming gradients of composition over the inter phase. This avoids creating a sharp inter phase (e.g., like the sharp inter phase between the active layer and the gas diffusion layer when they are laminated together using traditional air electrode production methods). More generally, disposing layers having similar compositions adjacent to one another can help reduce the risk of delamination.

Fourth, the production methods provide the ability to control the amount, type, and/or positioning of certain elements within a given sublayer of the air electrode (see, e.g., the x-y plane of FIG. 7). Control within a given sublayer can be achieved using a spray printing method (e.g., ink-jet-type spray printing). Methods including screen printing and/or masking can also be used. For example, screen printing or spray printing may allow for different materials (e.g., catalysts) to be printed at different positions within a sublayer to create a texture within the sublayer.

Some exemplary embodiments of production methods providing the ability to control the amount, type, and/or positioning of certain elements within a given sublayer of the air electrode will now be discussed. These exemplary embodiments are in no way intended to be exhaustive or limiting.

According to an exemplary embodiment, a sublayer is applied to a substrate using a screen printing process that results in blank portions. As discussed above, the blank portions substantially correspond to the locations where the coating-blocking material is disposed on the screen to form the stencil. In one exemplary embodiment, the blank portions remain substantially open (e.g., without air electrode material disposed therein, unobstructed, etc.) after an adjacent layer has been formed or applied. Thus, the sublayer composition varies within the sublayer itself between the presence of coating and the absence of coating. In another exemplary embodiment, the blank portions are at least partially filled during a subsequent coating material application (e.g., a coating material subsequently applied using a spray printing method may at least partially fill one or more of the blank portions). Thus, the composition of the sublayer is that of the coating resulting from the screen printing process at some locations and is that of the coating resulting from the spray printing process at other locations.

According to an exemplary embodiment, a single sublayer is formed on a substrate by two or more coating material applications using a screen printing process. Each coating forms a portion of the sublayer. In one exemplary embodiment, a first portion of the sublayer is defined by a first coating that includes a plurality of blank portions and that was formed from a first coating material. A second portion of the sublayer is defined by a second coating formed from a second coating material. The second coating is disposed in locations substantially corresponding to the locations of the blank portions in the first coating. In this way, the second coating is disposed in substantially the same plane as the first coating, and, together, the first coating and the second coating form the complete sublayer. This production method may include using a stencil for application of the second coating material that is substantially the inverse of the stencil used for application of the first coating material. In some exemplary embodiments, the blank portions may be only partially filled by the second coating. These blank portions may remain partially un-filled or one or more additional coating materials may be subsequently applied to fill or partially fill the remaining blank portions. In some exemplary embodiments, the resultant sublayer includes blank portions. In some exemplary embodiments, the resultant sublayer is substantially without blank portions. It should be noted that the composition of each coating forming a portion of the sublayer may differ or may be substantially similar to one or more other coatings forming other portions of the sublayer.

Fifth, using the above-described air electrode production methods, certain materials can be purposefully included or excluded at certain locations (e.g., portions, in sublayers, etc.) of the air electrode; the amount certain materials can be increased or decreased at certain locations; and the relative positions of certain materials can be controlled. As the presence, absence, amount, and/or position of certain materials can affect the performance, functionality and/or potential uses of the air electrode, the ability to control the composition and position of each sublayer formed during a multi-layer air electrode production process provides improved control the functionality, performance, and potential uses of a portion of a metal-air battery and/or the air electrode thereof For example, the production methods provide the ability to achieve multi-layer air electrode constructions with variations of the pore size, hydrophobicity, conductivity, catalyst loading, composition, additives, etc. through the air electrode.

A number of more specific benefits encompassed in the statement of the fifth benefit will now be discussed individually. It should be noted that the discussion of these specific benefits is not intended to be limiting or exhaustive.

One specific benefit is that including certain materials at certain locations provides for improved control over the functionality at these locations.

According to an exemplary embodiment, the amount and/or proportion of a catalyst in sublayers of an air electrode can be varied to increase the concentration of catalysts in the areas of reaction sites. By increasing the concentration of catalysts in areas of reaction sites, the overall reaction rates of the air electrode can be increased substantially without causing damaging side reactions (catalyst degradation, reaction on carbons (or other support materials), gas transport limitations or flooding, etc.). In some exemplary embodiments, the amount and/or concentration of a catalyst is varied in a manner configured to create a gradient of the catalyst within the air electrode or a portion thereof by using a printing or spin coating process. In one exemplary embodiment, the gradient may include a higher concentration of oxygen reduction catalysts on the electrolyte side of the active layer of the air electrode and a lower concentration of oxygen reduction catalysts on the gas diffusion layer side of the active layer, the concentration varying therebetween. In another exemplary embodiment, the gradient may include a higher concentration of oxygen evolution catalysts on the gas diffusion layer side of the active layer and a lower concentration of oxygen evolution catalysts on the electrolyte side of the active layer of the air electrode, the concentration varying therebetween. In yet another exemplary embodiment, the gradient may include a higher concentration of oxygen evolution catalysts on the electrolyte side of the active layer of the air electrode to improve power performance (e.g., in embodiments where gas nucleation is of less concern, such as in a flow battery). Alternatively, the catalyst gradient may extend along only part of the active layer of the air electrode (e.g., along the stacking axis, in the z-direction, etc.).

According to an exemplary embodiment, a surfactant gradient may be produced in an air electrode. A surfactant gradient may be utilized to provide a hydrophobicity gradient within the air electrode or a portion there of Generally, a sublayer having a relatively high surfactant concentration has a relatively high hydrophobicity. Surfactants can be removed from a sublayer by applying heat, thereby increasing the hydrophobicity of that sublayer. Different types of surfactants can be removed under different heating conditions (e.g., some types can be removed at relatively low temperatures, while other types require relatively high temperatures, etc.). Accordingly, by varying the concentration and/or type of surfactant included in the coating material used to form each sublayer, a surfactant gradient can be achieved. According to one exemplary embodiment, a surfactant gradient is created in an active layer by varying the type of surfactants included in the sublayers forming the active layer. The sublayers of an active layer disposed proximate to the electrolyte of a metal-air battery require relatively high temperatures in order to be removed, the surfactants included in the sublayers of the active layer disposed proximate to the gas diffusion layer can be removed at relatively low temperatures, and the temperatures at which the surfactants in the intermediate sublayers can be removed varies substantially continuously therebetween. When heat is applied, greater amounts and/or concentrations of surfactants will remain in the sublayers proximate to the electrolyte (relative to the layers closer to the gas diffusion layer); these layers will be less hydrophobic than the sublayers disposed proximate to the gas diffusion layer. As discussed in more detail below, it is desirable to have less hydrophobic layers disposed proximate to the electrolyte of a metal-air battery to improve initial wetting. According to another exemplary embodiment, the surfactant gradient is created by varying the concentration of surfactants in the sublayers. According to some exemplary embodiments, no surfactants are included in the sublayers of the active layer disposed proximate to the gas diffusion layer.

According to an exemplary embodiment, one or more sublayers of an air electrode are strategically composed and/or positioned to improve the initial wetting of the electrode in a metal-air battery. In traditional metal-air batteries, the hydrophobicity of the entire active layer is increased in order to produce a long lifetime air electrode. The high hydrophobicity of the surface exposed to the electrolyte results in slow penetration of the electrolyte (wetting) before the three phase boundary is established inside the active layer of the air electrode. As a result, formation cycles or an initial wetting stage is required before a battery including the air electrode can be used. With use of the above-described multi-layer air electrode production techniques, this initial wetting period can be substantially avoided.

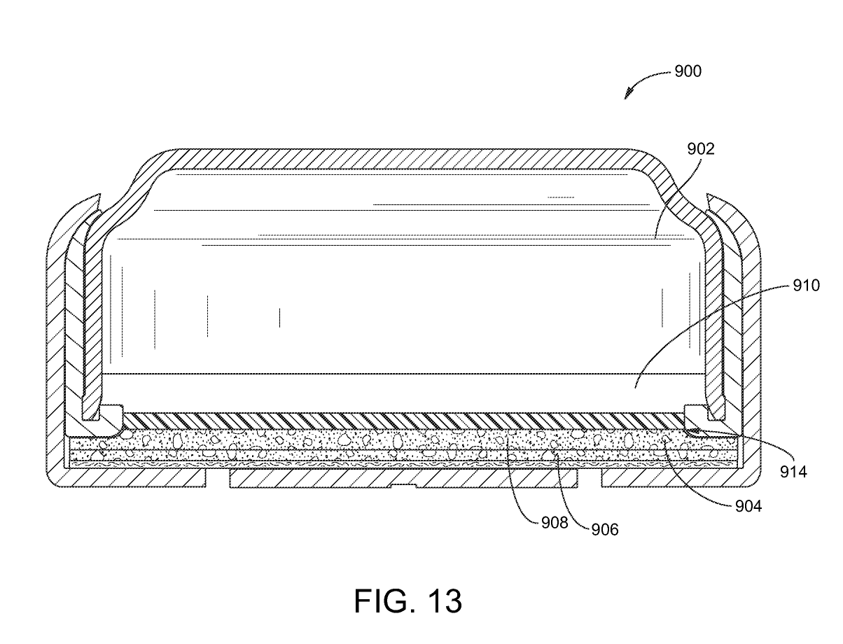

Referring to FIG. 13, a cross-sectional view of metal-air battery 900 configured to substantially avoid an initial wetting period is shown according to an exemplary embodiment. The metal-air battery is shown including a metal electrode 902, an air electrode 904 having a gas diffusion layer 906 and an active layer 908, and an electrolyte 910. The active layer 908 of the air electrode 904 is configured to have improved initial wetting. The active layer 908 includes one or more hydrophilic sublayers 912 (e.g., a super capacity type carbon, micro-porous low surface area carbon, etc.) disposed proximate to the electrolyte 910. The hydrophilic sublayers 912 promote initial wetting of an inner portion 914 of the air electrode (i.e., the portion disposed proximate to the electrolyte) without substantially influencing the overall lifetime performance of the air electrode 904. The remaining sublayers of the active layer 908 are typically hydrophobic. Additional benefits include improved functionality of wetting layer. It should be noted that the hydrophilic sublayers 912 may be formed by any printing process or coating process disclosed herein.

Referring further to FIG. 13, the hydrophilic sublayers 912 include super capacity carbon according to an exemplary embodiment (e.g., with a surface area of greater than 900 m²/g). The use of super capacity carbon provides for a relatively high or improved peak pulse capability to be achieved. This is related to the charge stored in the double layer capacitance of the air electrode. The double layer capacitance has a fast response time and, thus, can be used to load level current peaks. Generally, the capacity increases with an increased surface area. The increased capacity results in a very fast response time, and, accordingly, may help fast pulse performance.

Referring further to FIG. 13, according to another exemplary embodiment, the hydrophilic sublayers 912 include low-surface area carbon (e.g., with a surface area of less than 100 m³/g). Low surface area carbon exhibits resistance to corrosion and oxidizing of carbonates. Further, the low surface area carbon will wet rapidly, making it more difficult for the higher surface area carbons to release gas inside of the battery 900 because the wetted carbon of the active layer inter phase will help prevent gas from being transported into the inter phase. Gas trapped behind the first separator causes increased impedance during charge and discharge.

According to an exemplary embodiment, a method of producing an air electrode or a portion thereof configured to provide improved control of the initial wetting of the air electrode includes any of the above described multi-layer air electrode production processes followed by sintering and/or calendaring (to increase the mechanical strength of the electrode). According to one exemplary embodiment, the hydrophilic sublayers are relatively thin compared to the other sublayers. According to another exemplary embodiment, the hydrophilic sublayers are formed last (i.e., after the other sublayers of the air electrode). According to some exemplary embodiments, the hydrophilic sublayers may be formed other than last in the production of the active layer of the air electrode. According to other exemplary embodiments, the hydrophilic layers to be wetted include less than 15% wt of binders (e.g., PTFE, PE, PP, etc.). It should be noted that similar approaches may be used for other conditioning (e.g., pre-treating) of an air electrode.

Another specific benefit is that including certain materials at certain locations may also help control, limit, or avoid undesirable results. These undesirable results are typically the consequence of the presence of other air electrode materials, other components, or the operation of the air electrode itself. For example, recombination catalysts (e.g., CuO+Ru+Pt, CuO+Ni-alloys, metal hydride materials, etc.) may be included at certain locations of the air electrode where they are relatively more effective at seeking out and consuming hydrogen produced in a metal-air battery. In some exemplary embodiments, the recombination catalysts may be positioned close to the source of hydrogen from the zinc electrode, but still in a location where oxygen is present in the electrolyte (e.g., at or proximate to the electrolyte side of the active layer).

Another specific benefit is that excluding certain materials at certain locations may provide for improved control over undesirable results.

According to an exemplary embodiment wherein excluding certain materials at certain locations may provide for improved control over undesirable results, an air electrode utilizes carbon substrates and non-carbon substrates in strategic combination. The air electrode includes a gas diffusion layer and an active layer. The active layer includes non-carbon substrates (e.g., ceramic materials; porous materials such as Ag, Fe, Ni; metal hydride materials, etc.) and the gas diffusion layer includes carbon substrates. The use of non-carbon substrates in the active layer reduces the risk of carbonization from any carbon oxidation side reactions. Locating these non-carbon substrates in the active layer provides more benefit than including them in the gas diffusion layer because there is a greater possibility of carbon oxidation side reactions occurring in the active layer than in the gas diffusion layer (i.e., the more expensive non-carbon substrates are used in portions of the air electrode where they provide the most benefit). In one exemplary embodiment, this configuration may be achieved using a spin coating process. In other exemplary embodiments, this configuration may be achieved using a printing process, a dip coating process, an extrusion process, an injection molding process, traditional air electrode production process, and/or combinations thereof. In another exemplary embodiment, a first portion of the air electrode closer to the electrolyte than a second portion includes non-carbon substrates; the second portion includes carbon substrates.

Sixth, thin films of polymers and/or other novel materials can be included in the solution/coating material applied to a substrate to form a thin film. Inclusion of these thin films in air electrodes can be achieved using the above-described production methods (e.g., a spray coating process). In some exemplary embodiments, the polymers may be ion selective materials or gas selective materials. An ion selective polymer may provide for control of the electrolyte inter phase in an air electrode. A gas selective material (e.g., siloxane) may provide for control of the gas transport in an air electrode. In other exemplary embodiments, binders (e.g., PTFE, PE, PP, etc.) can be included in a solution to control the mechanical properties, gas and electrolyte penetration. In some exemplary embodiments, a thin film is applied that includes an ionic liquid that may provide improved control of the humidity interaction (vapor loss/gain).

Some additional applications of the above-described production methods, constructions achievable using these production methods, and benefits provided thereby will now be discussed. This discussion is not intended to be exhaustive.

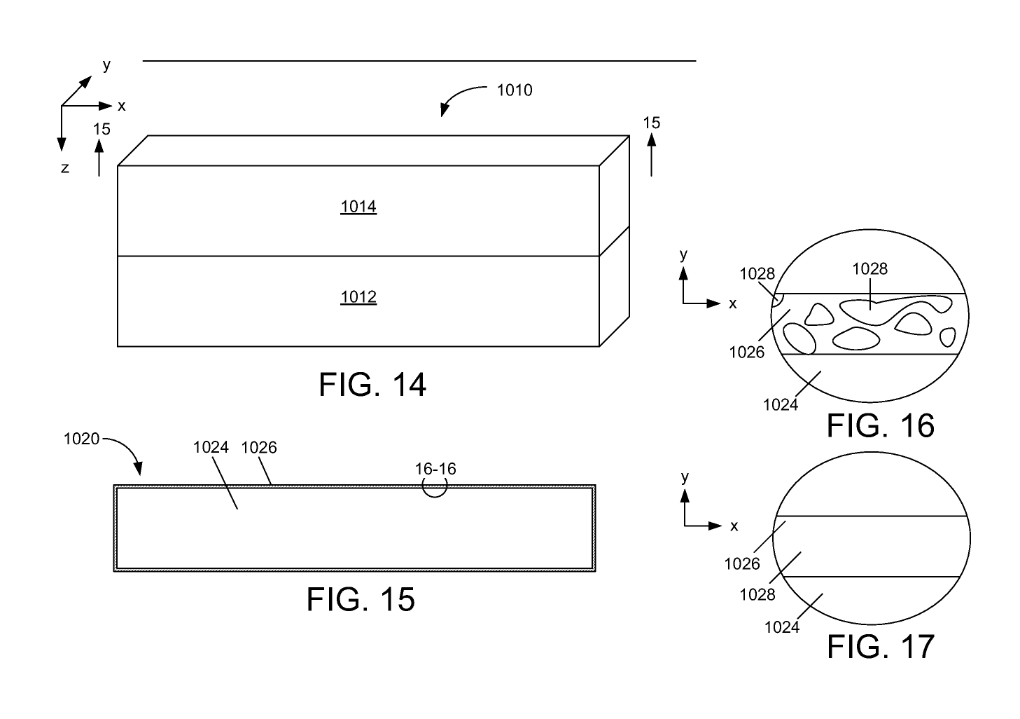

Referring to FIGS. 14-17, an air electrode 1010 including a gas diffusion layer 1012 and an active layer 1014 is configured to provide for improved venting of gases formed within a metal-air battery (e.g., during wetting of the air electrode). The active layer 1014 includes one or more sublayers 1020, each having one or more blank portions 1028. FIG. 15 shows one sublayer 1020 including a non-blanked region 1024 and a blanked region 1026, which includes the one or more blank portions 1028 according to an exemplary embodiment. The blank portions 1028 provide locations at which the hydrophobic portions of the gas diffusion layer 1012 are more directly exposed to the electrolyte side of the air electrode 1010 (e.g., portions of the gas diffusion electrode may show through to the electrolyte side of the air electrode, portions of the gas diffusion electrode may be reachable from the electrolyte side of the battery without having to pass through one or more layers of the active layer, at some locations (in an x-y plane) fewer layers of the active layer are disposed between the gas diffusion layer and the electrolyte side of the air electrode (in the z-direction), etc.). Having less of the active layer 1014 through which to travel, gases can more readily exit the metal-air battery and/or are less likely to be trapped therein. Improving gas ventilation helps prevent leakage, drying out of the metal-air battery, a loss in the power density and efficiency of a metal-air battery, and/or other problems known to be caused by gases trapped in a metal-air battery. While the blanked region 1026 is shown extending substantially about the periphery of the sublayer 1020, the blanked region may be otherwise sized, shaped, and/or positioned in other exemplary embodiments.

According to an exemplary embodiment, the blanked regions 1026 of the sublayers 1020 are produced using a screen stencil printing method. According to another exemplary embodiment, the blanked regions 1026 of the sublayers 1020 are produced using a spray printing method.

Referring to FIG. 16, blanked region 1026 is shown including a plurality of blank portions 1028 according to an exemplary embodiment. The blank portions 1028 are shown substantially randomly distributed, but may be deliberately patterned according to other exemplary embodiments.

Referring to FIG. 17, according to another exemplary embodiment, blanked region 1026 defines a single blank portion 1028, extending about the periphery of the one sublayer 1020. In some exemplary embodiments, a sublayer including one or more blanked portions may include multiple blanked or non-blanked regions. Further, any of these regions may define a single blank portion or include a plurality of blank portions. In other exemplary embodiments, one or more layers that do not extend to the perimeter of the air electrode (providing for ventilation about the perimeter) may be formed using any of the air electrode production methods described herein.

According to an exemplary embodiment, the plurality of sublayers 1020 have substantially identical blanked regions 1026 and are stacked such that the blanked regions 1026 substantially correspond (e.g., are aligned). The blank portions 1028 of the blanked regions 1026 substantially align to provide/form vents extending substantially along the stacking axis (see, e.g., the z-axis in FIG. 14) of the air electrode 1010. In some exemplary embodiments, the blank portions 1028 of the blanked regions 1026 may align to form vents that are in whole or in part disposed at an angle relative to the stacking axis.

According to an exemplary embodiment, a hydrophobic layer may be selectively printed generally about the periphery of one or more sublayers of an air electrode to improve sealing. The hydrophobic layer may be printed about the entire periphery (e.g., edges, etc.) of a layer, may be printed about part of the periphery, and/or may include a number of portions spaced apart generally about the periphery. According to some exemplary embodiments, the hydrophobic layer may be selectively printed using a screen printing method or a spray printing method. According to one exemplary embodiment, a hydrophobic layer is printed about the periphery of a sublayer at the end of a gas diffusion layer distal to the active layer of an air electrode. According to another exemplary embodiment, two or more hydrophobic layers are printed about the periphery of two or more sublayers of a gas diffusion layer at the side distal to the active layer of an air electrode.

Another benefit of the above-described multi-layer production methods is that they allow for the use of less material and/or better utilization of materials to produce a finished air electrode because of the improved control provided over the placement of component materials in the air electrode. Using less material and/or less of the more expensive materials results in a cost savings. Also, thinner and/or less voluminous air electrodes may be produced, which have a number of benefits, which are discussed in more detail below.

Another benefit of the above-described multi-layer air electrode production methods is that they allow an air electrode to be shaped in a manner that more efficiently utilizes the space defined by the housing (e.g., avoiding the creation of open, unutilized areas, etc.). In contrast, traditional air electrode production processes are limited by the mesh current collector, the wet or dry mixtures used, and/or other factors. Freeing up more space in the housing allows for the inclusion of a greater quantity or volume of desirable materials therein. For example, the capacity of a metal-air battery is generally directly related to the amount (e.g., volume) of the metal anode material that can be disposed within the housing of the metal-air battery. It follows that by increasing the amount of metal anode material in the housing of the metal-air battery, one can produce metal-air batteries having higher capacities. Accordingly, yet another benefit of the above-described air electrode production processes is that the capacity of a metal-air battery may be increased because more metal anode material can be included.

According to an exemplary embodiment of a metal-air battery configured to have increased capacity, the metal-air battery includes a housing and an air electrode. The air electrode includes a one or more sublayers each formed using a multi-layer air electrode production process (e.g., printing, spin coating, etc.) and provides for more efficient usage of space (e.g., occupies less space, does not prevent access to potentially-usable space, etc.) than an air electrode not produced using a multi-layer production process. At least part of the space made available through the use of the multi-layer air electrode is occupied by metal anode material, increasing the capacity of the metal-air battery. According to another exemplary embodiment, the more efficient usage of space allows for use of a housing that is smaller than housing used with metal-air batteries having the same capacity, but using air electrodes produced by more conventional production methods. Smaller housings may be useful in many applications wherein the device in which the battery is used is relatively small, wherein the device would be more desirable if it were smaller, etc.

By improving the ability to shape the air electrode, the air electrode production methods also allow for new, improved, and/or more complex air electrode shapes to be achieved. One application for these improved shaping abilities is in metal-air flow cells, which may benefit significantly from the use of air electrodes having non-traditional shapes as described in more detail in International Application PCT/US2010/040445 and corresponding U.S. patent application Ser. No. 12/826,383, each filed Jun. 29, 2010, the entire disclosures of which are incorporated herein by reference.

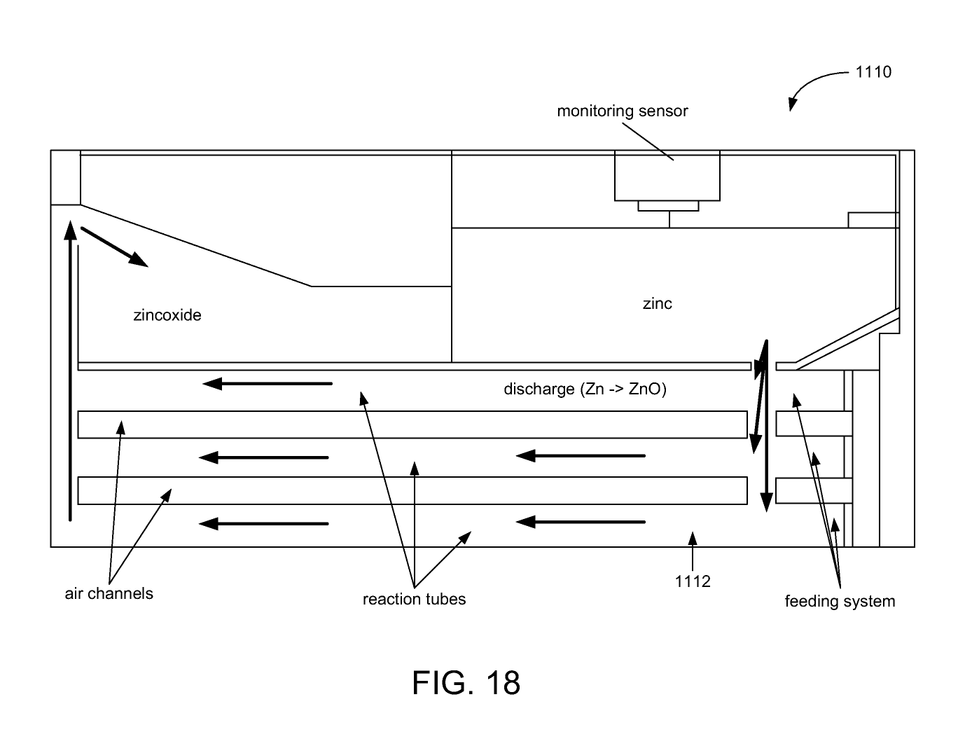

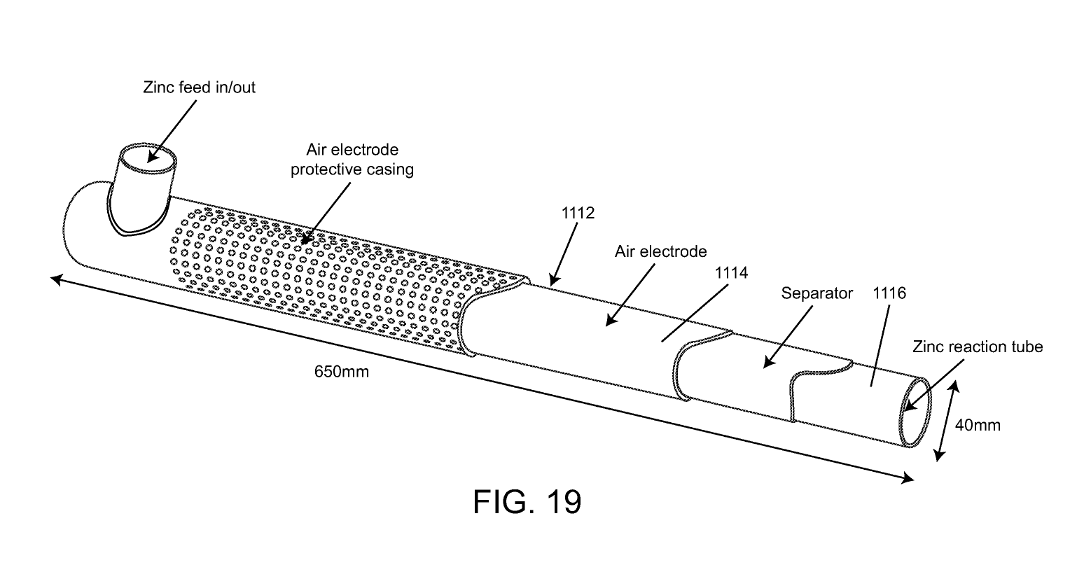

Referring to FIGS. 18-19, a metal-air battery, shown as a zinc-air flow cell 1110, includes one or more reaction tubes 1112 according to an exemplary embodiment. At least one reaction tube 1112 includes an air electrode 1114 having an active layer that has been spin coated onto a gas diffusion layer. To produce the air electrode, the gas diffusion layer is first produced and mounted to a support structure, shown as a zinc reaction tube 1116. The active layer is then spin coated onto the gas diffusion layer. According to one exemplary embodiment, the active layer is spin coated in one step. According to another exemplary embodiment, the active layer is spin coated in multiple steps (e.g., including varying the composition of the coating material, etc.). According to other exemplary embodiments, the active layer is spray printed or screen printed in one step or in several steps. According to some exemplary embodiments, the active layer is calendered and/or sintered after formation. While the method of mounting the gas diffusion layer and spin coating the active layer thereto is discussed with reference to a zinc-air flow cell, this method may be utilized in substantially any cylindrical, prismatic, or button metal-air battery. It should be noted that the support structure may be a housing or any other structure capable of supporting an air electrode in whole or in part.

The above-described air electrode production methods can be used to improve control over the reaction sites for the oxygen reduction and the oxygen evolution reactions in a bifunctional metal-air battery. Oxygen reduction takes place in the three phase boundary between the oxygen reduction catalysts, the electrolyte, and oxygen. Oxygen evolution is a two phase reaction between the oxygen evolution catalyst and the electrolyte. Accordingly, oxygen evolution will occur throughout the total wetted area of the air electrode.

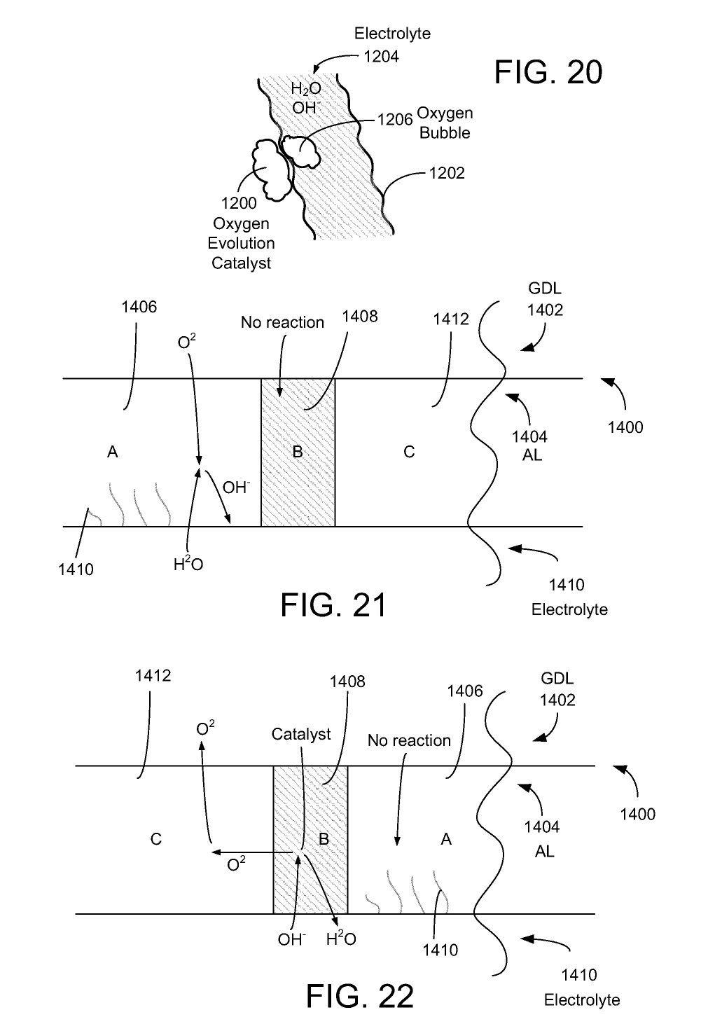

When used in closed metal air batteries, one main failure mechanism for bifunctional air electrodes is the result of oxygen formation during charging. During charging (oxygen evolution), oxygen formation takes place in flooded areas of the air electrode and the oxygen is not able to diffuse out of the electrode through the gas diffusion layer at a sufficient rate. Oxygen bubbles are nucleated in the electrolyte, creating dry spots which may increase impedance. Increased impedance results in an uneven current distribution on both the anode and the cathode. FIG. 20 provides an exemplary illustration of the operation of this failure mechanism. FIG. 20 shows an oxygen evolution catalyst 1200 disposed proximate to a channel 1202 filled with an electrolyte 1204 in an air electrode according to an exemplary embodiment. Oxygen formed by the oxygen evolution catalyst 1200 enters the electrolyte-filled channel 1202, forming an oxygen bubble 1206 therein. The oxygen bubble 1206, alone or in combination with other oxygen bubbles, causes a pressure build-up which pushes the electrolyte 1204 out of some locations, creating the dry spots as discussed above.

In flow type batteries, oxygen may be removed by the flow of the electrolyte and formation of gas bubbles may be avoided. The oxygen evolution catalyst may be on the electrolyte side and fully flooded with the electrolyte to increase the active surface area for the reaction. The oxygen reduction catalyst may be placed in a separate layer on the inside of the oxygen evolution reaction layer. The two layers may be separated by a separator or may be in electrical contact with one another.

According to an exemplary embodiment, an air electrode production process includes steps configured to concentrate (e.g., load, focus, etc.) oxygen evolution catalysts proximate to hydrophobic channels. The air electrode production process includes forming a gas diffusion layer by any of the new or improved methods described herein or by traditional methods. An active layer sublayer having a high oxygen evolution catalyst concentration is then applied to the gas diffusion layer. A catalyst gradient is created by the formation of additional air electrode sublayers; moving away from the gas diffusion layer, the catalyst concentration in the active layer sublayers decreases. After applying the sublayers that make up the catalyst gradient, one or more additional active layer sublayers are applied that include only oxygen reduction catalysts. After applying the sublayers that include only oxygen reduction catalysts, one or more additional active layer sublayers may be applied that include no catalysts. In one embodiment, oxygen evolution catalysts may be printed into a texture in a same area as binders to concentrate the oxygen evolution catalysts in the area.

Referring to FIGS. 21 and 22, an air electrode 1400 is shown configured to provide for improved venting of gas according to an exemplary embodiment. The air electrode 1400 includes a gas diffusion layer 1402 and an active layer 1404. The active layer 1404 is shown including a textured portion 1406, a flooded portion 1408 that is flooded with an electrolyte 1410, and a porous portion 1412. The textured portion 1406 includes predominantly oxygen reduction catalysts, carbon, and one or more binders to create a three-phase boundary for oxygen reduction. Some of the electrolyte 1410 is disposed in the pores of the textured portion 1406. The flooded portion 1408 includes oxygen evolution catalysts to create a two-phase boundary for oxygen evolution. The porous portion 1412 includes one or more binders and is configured to allow for oxygen transport out of the active layer 1404. It should be noted that the flooded portion 1408 may further includes some binder material (e.g., PTFE).

FIG. 21 illustrates the air electrode 1400 and the electrolyte 1410 during discharge. During discharge there is a reaction in the textured portion 1406 and there is no reaction in the flooded portion 1408. As mentioned above, the oxygen reduction reaction takes place in the textured portion 1406.

FIG. 22 illustrates the air electrode 1400 and the electrolyte 1410 during charge. During charge, there is no reaction in the textured portion 1406 and there is a reaction in the flooded portion 1408. As mentioned above, the oxygen evolution reaction takes place in the flooded portion 1408.

The air electrode production process used to form the exemplary embodiment shown in FIGS. 21 and 22 may include co-printing hydrophobic materials or channels in the vicinity of the oxygen evolution catalysts. According to one exemplary embodiment, screen printing is used. According to another exemplary embodiment, spray printing is used. According to still other embodiments, other printing methods providing a sufficient level of control within the plane of a sublayer (e.g., x-y control) when locating materials may be used.

Generally, the above-described air electrode production processes and/or air electrode configurations achieved thereby provide for the separation of the position for the two reactions in the air electrode, the oxygen evolution reaction during charging and the oxygen reduction reaction during discharge. This separation allows for independent optimization of the reactions. The method used to separate the position of the reactions may differ based on the type of battery (e.g., prismatic cell, coin cell, flow battery, etc.). In some embodiments (e.g., with a flow battery), an air electrode stability level of more than 3,500 hours at 100 mA/cm² on discharge and more than 2,000 hours at 100 mA/cm² on charge may be achieved by separating reactions into two separate layers.

In traditional bifunctional air electrodes, the hydrophobic channels are the same for both the oxygen evolution and the oxygen reduction reactions. As the oxygen reduction reaction is a 3-phase reaction and the oxygen evolution reaction is a 2-phase reaction, the structure used in a traditional bifunctional air electrode is not optimal, and this structure may cause a metal-air battery to fail because of gas transport issues.

According to an exemplary embodiment, an air electrode production process that allows for control over the location of materials in the x-y plane may be used to create hydrophobic channels that provide for improved venting of oxygen formed during charging. The hydrophobic channels can be formed by positioning hydrophobic sublayers close to the reaction sites for oxygen evolution towards the side of the active layer proximate to the gas diffusion layer to allow for better venting of oxygen out of the air electrode.

According to an exemplary embodiment, control over water and OH⁻ transport can be improved by varying the hydrophobicity of the pore structure within the active layer. For example, sublayers having a high PTFE composition may be located proximate to the gas diffusion layer side of the active layer and sublayers having a low PTFE composition may be located proximate to the electrolyte side of the active layer. Varying the PTFE concentration within sublayers in the active layer may limit the flooding of the electrolyte in the electrode and prolong the lifetime of the battery under discharge and/or charge.

Alternatively, the transport channels can be formed in the active layer by including an ion exchange polymer in the coating material, which is used to create polymer channels within the active layer. Generally, capillary forces push a liquid electrolyte into the pores of an air electrode. When used in coating materials, ion exchange polymers form polymer channels intended to transport the electrolyte or fill the pores of the air electrode polymer material. As a polymer is generally less mobile than a liquid electrolyte, improved control over water and OH⁻ transport can be achieved.

In some embodiments, selective layers may be incorporated into or onto an air electrode using a spin coating method (e.g., spin coating a selective layer onto a gas diffusion layer). A selective membrane may also be disposed directly onto a housing using spin coating or another process described herein. Sublayers that are selective membranes may be ion selective or gas selective (e.g., oxygen, water vapor, carbon-dioxide, etc.). Further, two or more selective membranes or layers may be used in combination (e.g., one or more layers of porous plastic materials, one or more metal layers, etc.) to improve a desired ion or gas selectivity within a metal-air battery.

According to an exemplary embodiment, a siloxane layer can be used as the support for the deposition of a thin (submicron to nanometer) thin solid (non porous) silver film (e.g., deposited by chemical vapor deposition, etc.). The silver film is selective for oxygen, and siloxane will allow high oxygen transport rates. According to other exemplary embodiments, a multi-layer production process other than spin coating may be utilized to apply a selective membrane.

According to an exemplary embodiment, the selective membrane is a siloxane membrane (e.g., Geniomer® 80 from Wacker Chemie AG of Munich, Germany), which is configured to reduce the influence of CO₂ and H₂O exchange. The siloxane membrane may be configured to be relatively thick without substantially reducing the power capability of a metal-air battery. The diffusion coefficient of the siloxane membrane is not dependent on the thickness of siloxane membrane. Within a certain range, the thickness of the siloxane membrane does not significantly decrease the limiting current because the siloxane membrane has a relatively high oxygen transport capability (e.g., rate and/or quantity, rate capability, etc.) because its oxygen diffusion coefficient is relatively high. For example, with target current densities from 5 mA/cm² to 150 mA/cm² (which covers most consumer-based applications discussed herein) the oxygen diffusion coefficient (D_{O2}) for a 20 μm thick film the D_{O2} is between 2.8E−11 and 8.2E−10 m²/s. In case of a 10 μm thick film the D_{O2} is between 1.4E−11 and 4.1E−10 m²/s. Different applications have different current density needs, and, accordingly, the thickness of the selective membrane may be tailored to achieve a desired current density. According to other exemplary embodiments, any selective membrane material having a thickness/diffusion coefficient combination sufficient to both stabilize a metal-air battery while maintaining a desired performance level may be utilized. The use of siloxane and other selective membranes is discussed in more detail in U.S. Provisional Patent Application Ser. No. 61/230,550, titled “Metal-Air Battery with Humidity and CO₂ Management,” which is incorporated herein by reference in its entirety.

According to another exemplary embodiment, a selective membrane, such as a siloxane membrane, may be made conductive for use as or on the gas diffusion layer. For example, materials (e.g., in the form of particles) may be added to the siloxane membrane to allow the siloxane membrane to function as the current collector for the battery cathode. Exemplary conductive materials include, but are not limited to, carbon particles and metallic particles.

According to an exemplary embodiment, an air electrode production process includes printing a current collector. Printing the current collector eliminates the need for a mesh current collector to be pressed into the active layer of the gas diffusion layer of the air electrode and reduces the risk of delamination of the active layer and the gas diffusion layer. Printing the current collector also saves space within the metal-air battery because a printed collector is typically thinner and occupies less volume than a mesh current collector, providing an opportunity to increase the capacity of the battery, include greater quantities of desirable materials, and/or use a smaller housing. According to one exemplary embodiment, the current collector is printed using a screen printing method. According to other exemplary embodiments, any printing process disclosed herein may be used to print the current collector.

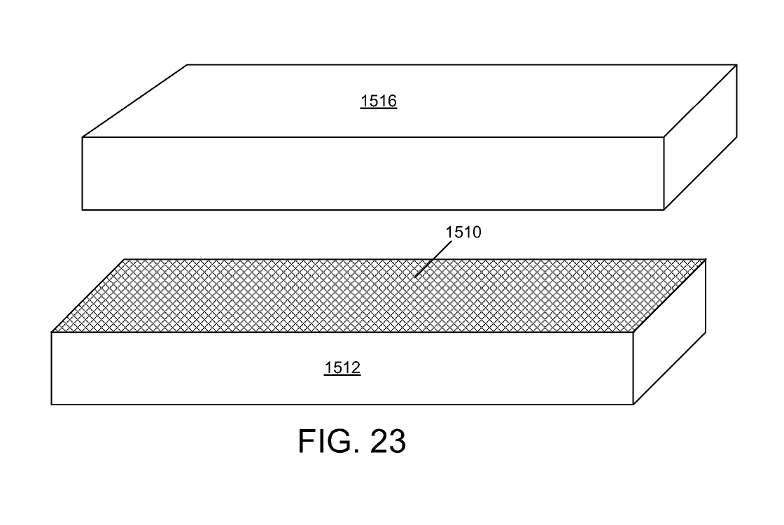

Referring to FIG. 23, a current collector 1110 is shown printed onto a surface of a gas diffusion layer 1112 according to an exemplary embodiment. An active layer 1116 may be subsequently produced and coupled and/or disposed adjacent to the current collector 1110. It should be noted that the gas diffusion layer may be formed using any process disclosed herein or a traditional gas diffusion layer production process.

According to an exemplary embodiment, the current collector is a printed current collector that is disposed at a central portion of a gas diffusion layer of an air electrode (e.g., along the z-direction). The current collector includes a first portion of the gas diffusion layer disposed to a first side and a second portion of the gas diffusion layer disposed to a second side generally opposite the first side.

The conductivity of an air electrode can be improved by utilizing the above-described air electrode production processes. By strategically composing and positioning sublayers, conductive pathways can be formed in an air electrode. These layers typically include carbon and/or metals and may be positioned in the active layer and/or the gas diffusion layer. These conductive pathways result in less ohmic losses for electrons, improving electron travel within the air electrode. By using these sublayer structures, the conductivity of the electrode can be improved because the electrons travel by particle to particle contact.

In some embodiments, an injection molding process may be used to form an air electrode, portions of an air electrode, and/or other metal-air battery components.

While it is well known to use injection molding for plastic parts, the inventors' surprising finding that using PE and/or PE as a binding material in electrodes can provide improved mechanical strength for the air electrode allows novel methods of producing metal-air battery components that utilize injection molding to be used. This surprising finding further allows for novel configurations (e.g., shapes), constructions, and applications for metal-air batteries and components thereof.

According to an exemplary embodiment, an injection molding process may be used to form the air electrode of a metal-air battery or a portion thereof. Where the gas diffusion layer and the active layer are both formed using an injection molding process, they may be formed separately or in combination.

The inventors have unexpectedly determined that plastic materials such as PP (polypropylene) and PE (polyethylene) perform well as air electrode binders. For example, the binding properties of PP and PE reduce chemical or mechanical degradation of the air electrode during operation. Further, by greatly enhancing the mechanical strength of the air electrode, these polymers provide for new air electrode shapes, constructions, and functions. Similar to the multi-layer construction methods discussed above, new air electrode shapes may also allow for use of smaller battery housings, inclusion of more metal-anode material, etc. According to some exemplary embodiments, one or more rubber materials (e.g., silicon) may be used in combination with PP and/or PE, as discussed in more detail below.

According to an exemplary embodiment, PP and/or PE can be used as the sole binders in an air electrode or a primary layer thereof, replacing more conventional binders (e.g., PTFE).

According to an exemplary embodiment, PP and/or PE are used in combination with PTFE (or other more conventional binders) in the air electrode. Such a combination may provide for a balancing of the benefits of PTFE, which is known to be one of the best oxygen transport materials, and PP and PE, which have been found to increase the mechanical strength of the air electrode. In some exemplary embodiments, the composition of the binders in each of the primary layers of the air electrode is the same (e.g., the gas diffusion layer and the active layer both use PP in combination with PTFE). In other exemplary embodiments, the composition of the binders in the different primary layers of the air electrode varies (e.g., the gas diffusion layer includes PE used in combination with PTFE and the active layer includes only PE). In still other exemplary embodiments, the composition of the binders may be varied by sublayer.

According to one exemplary embodiment, binders (e.g., binding agents such as PE and/or PP, alone or in combination with PTFE or another binder) are added to a powder mixture including other materials used to form one or more of the primary layers of the air electrode (e.g., the active layer, the gas diffusion layer, etc.). According to one exemplary embodiment, PP and/or PE binders are added in the form of fine particles.

The powder mixture is heated to a temperature above the melting point of the PP and/or PE and mixed using a blender or other suitable mixing device. Once the PP and/or PE has been melted, the resultant liquid is forced into a mold using a pump, piston, or feed screw. The temperature of the PP and/or PE is then reduced to solidify the liquid to form an air electrode or portions thereof. The resultant injection molded “part” may then be removed from the cavity of the mold.

The mold includes a cavity corresponding to the desired shape of an air electrode or portions thereof (e.g., the gas diffusion layer and/or the active layer, a sublayer of a primary layer, etc.), and may be made from any suitable material, including steel, aluminum, or other materials used to form molds for use in injection molding operations. The molds may include flat portions, curved portions, textured portions, combinations thereof, etc.

The use of an injection molding process may allow the formation of parts having a wide variety of shapes, sizes, and configurations. According to an exemplary embodiment, the air electrode may be formed to substantially correspond to the shape of a battery housing or other structure (e.g., a housing for a cylindrical cell, a button cell, or a prismatic cell, etc.). This may particularly useful in forming air electrodes for applications where size constraints are critical (e.g., small batteries such as hearing aid batteries).

Another benefit of the injection molding process is that it allows an air electrode to be shaped in a manner that more efficiently utilizes the space defined by the housing (e.g., avoiding the creation of open, unutilized areas, etc.). Freeing up more space in the housing allows for the inclusion of a greater quantity or volume of desirable materials therein. For example, the capacity of a metal-air battery is generally directly related to the amount (e.g., volume) of the metal anode material that can be disposed within the housing of the metal-air battery. It follows that by increasing the amount of metal anode material in the housing of the metal-air battery, one can produce metal-air batteries having higher capacities. By utilizing materials such as PP/PE within the air electrode, the active surface area of the air electrode may be increased, which in turn allows the battery to deliver higher amounts of power for a given battery volume.

According to an exemplary embodiment of a metal-air battery configured to have increased capacity, the metal-air battery includes a housing and an air electrode. At least part of the space made available through the use of the air electrode production process is occupied by metal anode material, increasing the capacity of the metal-air battery. According to another exemplary embodiment, the more efficient usage of space allows for use of a housing that is smaller than housing used with metal-air batteries having the same capacity, but using air electrodes produced by more conventional production methods. Smaller housings may be useful in many applications wherein the device in which the battery is used is relatively small, wherein the device would be more desirable if it were smaller, etc.

According to a particular exemplary embodiment, air electrodes for use in a flow battery such as that shown in FIG. 6 may be produced in whole or in part using an injection molding process. The gas diffusion layer and the active layer may be injection molded into a tubular shape or may be formed flat and wrapped about a support structure to achieve a tubular shape (the gas diffusion layer and active layer may be formed separately or may be formed together in a single injection molding operation.

Injection molding processes may be incorporated into the air electrode manufacturing process in a variety of different manners. For example, according to one exemplary embodiment, a gas diffusion layer mixture may be melted and injected into a mold. The injected mixture may then be cooled and removed from the mold to form a gas diffusion layer. An active layer for the air electrode may then be applied to the gas diffusion layer (e.g., using spray printing, screen printing, spin coating, dip coating, or another suitable process). The active layer may then be heat sintered.

According to another exemplary embodiment, an air electrode production process includes injection molding a first layer of an air electrode. Successive layers are then formed on the first layer using a printing, spraying, spin-coating, dip-coating, or other suitable process. According to one exemplary embodiment, the first layer is the gas diffusion layer. According to some exemplary embodiments, the active layer may be formed onto an injection molded gas diffusion layer using a spin coating and/or spray printing process. According to another exemplary embodiment, the first layer is an active layer. According to some exemplary embodiments, the first layer is a sublayer of a primary layer.

According to another exemplary embodiment, a complete air electrode may be formed during a single injection molding process. The injection molding process may be configured to provide for the use of two or more different mixtures of material (e.g., using two separate injection nozzles to keep the materials separate), providing for distinction between the gas diffusion layer, the active layer, and possibly sublayers used to form one or both of these primary layers.

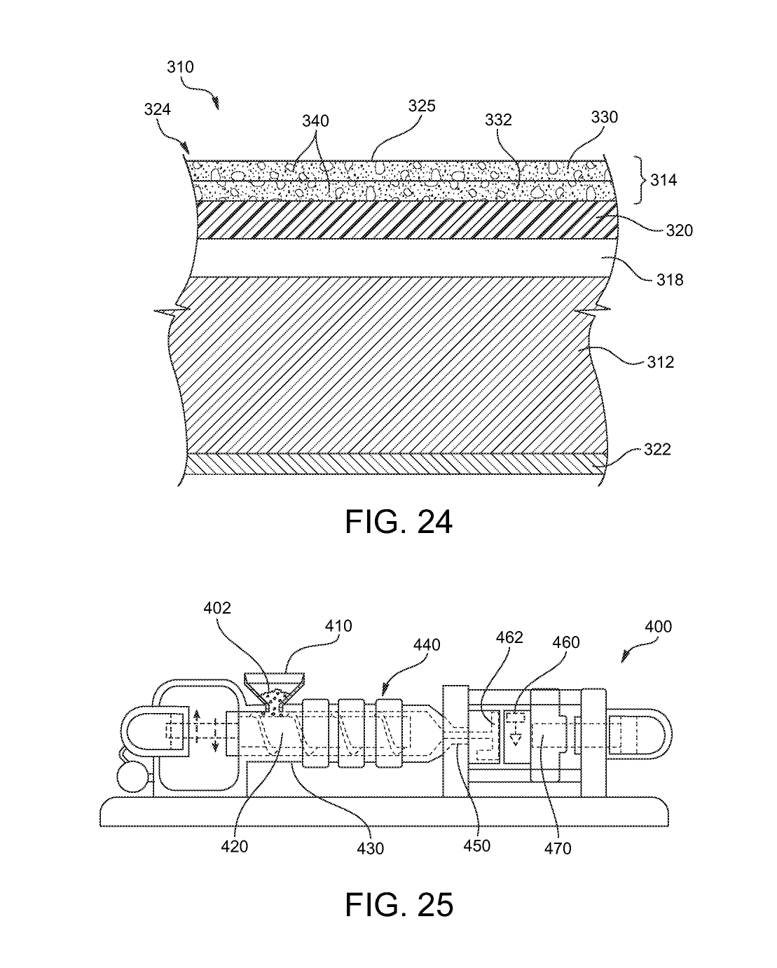

According to an exemplary embodiment, an air electrode may be injected molded to form and function as the housing of a metal-air battery (e.g., for hearing aids, portable electronics, etc.). FIG. 24 illustrates a cross-sectional view of a battery 310 a housing formed from a first portion 322 and a second portion 324. Within the housing are a metal electrode 312, a separator 318, and a separator 320. Such internal components may have any of the configurations as discussed with respect to the various exemplary embodiments described herein. The first portion 322 of the housing may be formed of a material such as a metal, polymer, composite, or other suitable material. The second portion 324 of the housing is provided as an air electrode 314 having a gas diffusion layer 330 and an active layer 332 (having binding agents 340 provided therein). The second portion 324 may be formed in an injection molding or other suitable process, and the active layer and/or the gas diffusion layer may include a binder composition that uses polymeric materials such as PP and/or PE in place of or in addition to PTFE or other more conventional binder materials. According to an exemplary embodiment, the second portion 324 is configured such that the air electrode is directly exposed to the atmosphere outside of the battery 310 and forms an outer surface 325 of the housing. The second portion 324 may be secured to the housing 322 by welding, gluing, or any other suitable connection method. Because the gas diffusion layer 330 of the housing is directly exposed to the surrounding atmosphere, a uniform oxygen distribution may be obtained throughout the air electrode.

According to another exemplary embodiment, the entire housing of the battery may be formed of an air electrode material such as air electrode 314, in which case a separator or other structure would be provided between the entire inner surface of the housing and the metal electrode to prevent short circuiting of the battery.

The formation of a battery having an exterior surface that is formed of an air electrode may have utility in a variety of applications, including cellular phones, computers, and other electronic devices. One advantageous feature of such a configuration is that a portion of the housing may be eliminated (along with an optional oxygen distribution layer 16 between the housing and the air electrode), which may result in a more compact battery size, which may in turn allow for space savings within the electronic device (or, alternatively, may allow more active materials such as the metal anode to be included within the battery, depending on the desired performance characteristics of the battery).

In addition to more traditional battery housing shapes (e.g., housings configured for use as coin or button cells, prismatic batteries, cylindrical batteries, etc.), other more non-conventional battery configurations may be created (e.g., custom conformable device inserts, etc.). Because the air electrode 314 may be formed into any of a variety of complex shapes as a result of the binder materials used therein, the housing may be configured to conform to any of a variety of form factors that may be useful for a particular application. The size and shape of such batteries may vary according to any of a number of factors.

FIG. 25 illustrates an injection molding machine 400 that may be used to form an air electrode or a component thereof according to an exemplary embodiment. The injection molding machine includes a hopper 410 into which a material 402 is fed (e.g., gravity fed). The material 402 may include all of the constituents to be included in the air electrode, including carbon materials, binders, catalysts, and any other materials that will be incorporated into the air electrode (e.g., an ion exchange material, etc.). A feed device 420 such as a screw or augur may direct the material along the length of a barrel 430 that may be heated using a device such as a heater 440. Once the material 402 is melted, it may be directed through a nozzle 450 into a cavity 462 of a mold 460. The nozzle 450 and mold 460 may have any desired configuration, and the cavity 462 within the mold 460 will define the size, shape, and configuration of the molded air electrode. A moveable platen 470 may be configured to open and close to allow removal or ejection of the molded air electrode. The molded air electrode may then be cooled according to any suitable method. Although FIG. 25 illustrates an exemplary embodiment of an injection molding apparatus, it will be appreciated by those reviewing the present disclosure that other configurations may be possible, and are intended to be included within the scope of this disclosure.

Referring to FIGS. 18-19, according to another exemplary embodiment, the air electrode 714 of the zinc-air flow cell 710 may be formed in whole or in part using an injection molding process. The gas diffusion layer may be injection molded into a tubular shape or may be formed flat and wrapped about a support structure to achieve a tubular shape. An active layer may then be spray printed onto the gas diffusion layer. The resultant air electrode 714 is shown substantially tubular and configured (in combination with other metal-air battery components) to provide for transport of zinc-anode material therethrough. According to another exemplary embodiment, the active layer may be formed using one or more of the above-described multi-layer air electrode production processes and/or may be produced before the gas diffusion layer.

According to an exemplary embodiment, an air electrode is produced by an air electrode production process involving the use of an injection molding. The air electrode production process includes five steps. First, a gas diffusion layer mixture is created. Second, the gas diffusion layer mixture is melted and injected into a mold. Third, the gas diffusion layer is removed from the mold. Fourth, the active layer is spray printed onto the gas diffusion layer formed using injection molding. Fifth, the active layer is heat sintered.

According to an exemplary embodiment, an air electrode production process includes injection molding a first layer of an air electrode. Successive layers are then formed on the first layer using a printing process. According to one exemplary embodiment, the first layer is the gas diffusion layer. According to some exemplary embodiments, the active layer may be formed onto an injection molded gas diffusion layer using a spin coating and/or spray printing process. According to another exemplary embodiment, the first layer is an active layer. According to some exemplary embodiments, the first layer is a sublayer of a primary layer.

According to an exemplary embodiment, a complete air electrode is formed during a single injection molding process. The injection molding process may be configured to provide for the use of two or more different mixtures of material, providing for distinction between the gas diffusion layer, the active layer, and possibly sublayers used to form one or both of these primary layers.

According to an exemplary embodiment, an air electrode is injected molded to form and function as the housing of a metal-air battery (e.g., for hearing aids, portable electronics, etc.). Accordingly, some of the battery function is integrated with the housing. Further, the ability to utilize the air electrode as the housing of a metal-air battery (or a portion thereof) allows the metal-air battery itself to be injection molded into many shapes (e.g., various shapes of button cells and prismatic cells, custom conformable device inserts, etc.). The air electrode molded to form and function as a housing may be sealed (e.g., using ultrasonic welding, by being hot stamped, etc.).

According to any exemplary embodiment, an air electrode production process including an injection molding process may further include any one or more of the multi-layer air electrode production processes discussed above and/or an extrusion process (discussed in more detail below). Strategic combinations of these processes may be used to improve performance, reduce cost, and/or achieve other benefits disclosed herein.

In some embodiments, the metal anode of a metal-air battery may be polymerized. To form a polymerized metal anode, metal anode particles are mixed with an anion exchange material and a solvent to form a paste. As the solvent is evaporated, a coating of the anion exchange polymer is formed inside the paste around the zinc particles and an anion exchange polymer film is formed around the paste. The anion exchange polymer film around the paste forms (e.g., acts, functions as, creates the structure of, etc.) the separator for the battery. To facilitate the formation of the anion exchange separator, some pressure (e.g., by stamping) can be applied to the paste as the solvent is evaporated. To assemble the complete metal-air battery, the air electrodes are injection molded to include a hole configured to receive a zinc paste insert. The zinc paste is injected into the molded air electrode before the solvent has substantially evaporated, and then, as the solvent starts to evaporate, some pressure is applied to the zinc paste to facilitate formation of the separator in the inter phase between the anode and cathode. When the solvent has sufficiently evaporated, electrolyte is added in order to activate the ion exchange material. The current collector for the cathode (air electrode) is placed on the outside surface of the battery. The current collector for the anode (zinc electrode) can be inserted as a pin through the filling hole for injection of the zinc paste and might also be designed so that it forms a sealing part for the battery.

One benefit of this production method is that it is an all-in-one production process that reduces cost and allows for improved flexibility of design as well as improved metal-air battery manufacturing speed.

A polymerized metal anode may be used in combination with any traditional metal-air battery components and/or any of the novel metal-air battery components discussed herein. For example, a polymerized metal anode may be used with any alkaline electrolyte or an ionic liquid electrolyte.

According to an exemplary embodiment, a process for polymerizing a metal anode includes providing or creating a solution including a polymer (e.g., an ion exchange polymer, etc.). The solution is then mixed with the metal anode material (e.g., zinc). The solvent is evaporated from the solution and then activated by adding hydroxide and water. Heat may or may not be applied during the evaporation step. In one exemplary embodiment, the solution may include an OH⁻-conductive polymer solvent. In another exemplary embodiment, the proportion of the metal anode material to solvent is approximately within the range of 1:1-1:5.

According to an exemplary embodiment, an air electrode or a portion or layer thereof may be formed using an extrusion process. Utilizing extrusion methods allows for the creation of air electrodes or portions thereof having complex cross-sectional shapes and provides the ability to work with relatively brittle materials because materials encounter substantially only compressive and shear stresses during extrusion. Extrusion methods may also help achieve excellent surface finishes and increase the binding properties of layers.

Generally, an extrusion process includes pushing or drawing material through a die of the desired cross-section. The extrusion process may be performed with hot material or cold material. According to an exemplary embodiment, the extrusion process is a continuous process in which the air electrodes may be cut to the appropriate length upon or after exit from the extruder. Generally, continuous extrusion processes provide a relatively high level of efficiency (e.g., air electrodes can be produced quickly, low levels of scrap materials are generated, etc.). According to other exemplary embodiments, the extrusion process may be a semi-continuous or a discontinuous process.

According to an exemplary embodiment, the active layer and the gas diffusion layer are co-extruded in one step to produce the air electrode. The materials for the active layer and the gas diffusion layer are mixed with a solvent to form separate pastes. The pastes are then pushed through extruders that are disposed substantially in parallel to form a predefined shape (e.g., flat plates may be used to form a layer having a substantially rectangular cross-section). After being extruded, the layers are disposed adjacent to one another (e.g., sandwiched together) and heat and/or pressure are applied (e.g., via hot extrusion, lamination, calendering, etc.) to couple the active layer to the gas diffusion layer. In one exemplary embodiment, layers formed using an extrusion process may be laminated to bind them into a combined layer. In another exemplary embodiment, layers formed using an extrusion process may be calendered to achieve a desired thickness and/or to link the binders. In some exemplary embodiments, a current collector is provided and disposed between the gas diffusion layer and the air electrode layer before heat and/or pressure are applied (e.g., via calendering, hot pressing, etc.).

According to an exemplary embodiment, a gas diffusion layer is produced using an extrusion process. An active layer is then formed on the gas diffusion layer using a process such as printing, spin coating, etc. (where the active layer is formed of multiple layers, each layer may be formed using the same process or different processes may be used to form one or more of the layers). In some exemplary embodiments, one or more processes including the application of heat and/or pressure are used after the active layer is completed and/or during the air electrode production process.

According to an exemplary embodiment, an active layer is produced using an extrusion process. A gas diffusion layer is then formed on the active layer using a process such as printing, spin coating, etc. (where the gas diffusion layer is formed of multiple layers, each layer may be formed using the same process or different processes may be used to form one or more of the layers). In some exemplary embodiments, one or more processes including the application of heat and/or pressure are used after the gas diffusion layer is completed and/or during the air electrode production process.

According to an exemplary embodiment, an extrusion process may be used to form a cylindrical air electrode for a cylindrical battery (e.g., AA, AAA, a flow/reaction tube (see FIG. 19), etc.). These cylindrical air electrodes may be formed quickly and efficiently. Further, the scrap waste resulting from the production process is minimal.

According to an exemplary embodiment, the extrusion process used to form all or a portion of the air electrode may be a screw-type extrusion process. Such an extrusion process has not previously been used in the formation of air electrodes, since the materials conventionally used to form air electrodes do not have sufficient mechanical strength to allow for the use of such a process while still maintaining suitable conductivity and air diffusion properties. It has been discovered, however, that when binding agents such as PP and/or PE are added in addition to or in place of conventional binders used in air electrodes that the increased mechanical strength of the resulting material may be readily formed into desired shapes using a screw extrusion process.

Screw-type extrusion processes typically include the use of one or more screws (e.g., having a single screw configuration, having a twin screw configuration, etc.) to feed the material/paste for the air electrode through a die having an opening at the end thereof. The material fed through the die may include active layer material, gas diffusion layer material, and/or the material of any other air electrode layer. According to an exemplary embodiment, a screw-type extrusion process includes the use of a material including plastic materials that melt (e.g., PP, PE and/or PTFE), carbons, and catalysts. The material may be provided as a wet or dry material, and the material will melt as a result of applied pressure and heat within the extruder, facilitating the extrusion process. According to one exemplary embodiment, PP and/or PE are used as binding agents because, among other reasons, PE and PP resist becoming brittle during extrusion and have lower melting temperatures than PTFE.

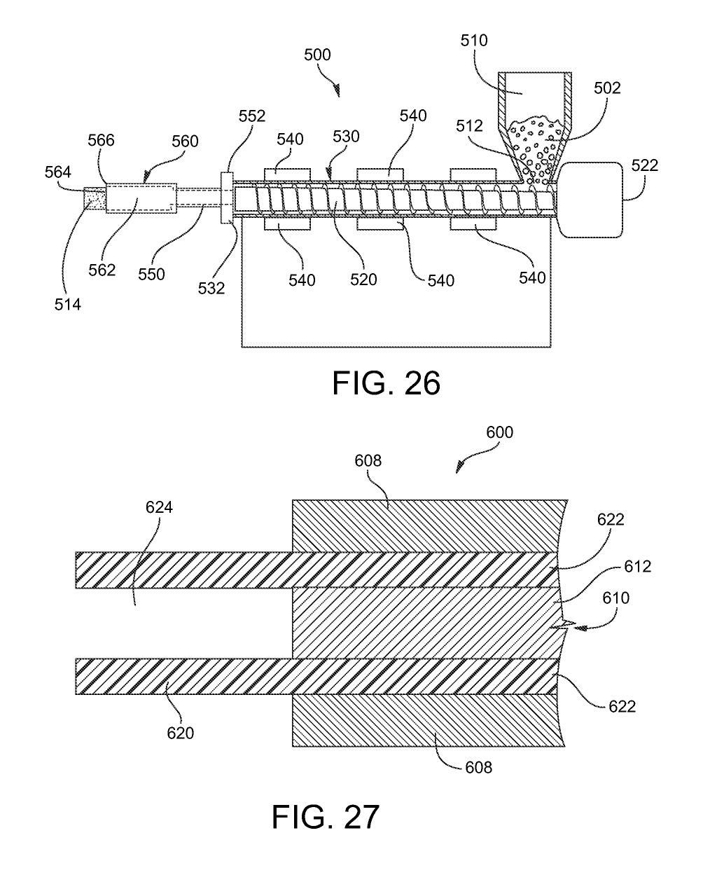

FIG. 26 illustrates an exemplary embodiment of a screw-type extruder 500 that may be used to form an air electrode or a component thereof according to an exemplary embodiment. The extruder 500 includes a hopper 510 into which a material 502 is fed (e.g., gravity fed). The material 502 may include all of the constituents to be included in the air electrode, including carbon materials, binders, catalysts, and any other materials that will be incorporated into the air electrode (e.g., an ion exchange material, etc.). A feed device 520 such as a screw or augur that is driven by a motor 522 may direct the material along the length of a barrel 530. The material 502 enters the barrel 530 through a feed throat 512 and comes into contact with the feed device 520. The rotating screw forces the material 502 forward along the length of the barrel 530 which is heated using one or more heaters 540 positioned along the length of the barrel to the desired melt temperature of the material 502. According to an exemplary embodiment, a heating profile for the barrel 530 may be set in which three or more independent zones gradually increase the temperature of the barrel from the rear (where the material 502 enters) to the opposite end of the barrel 530. This allows the material 502 to melt gradually as it is pushed through the barrel 530 and lowers the risk of overheating which may cause degradation in the material 502. Extra heat is contributed by the pressure and friction within the barrel 530. According to an exemplary embodiment, the heaters 540 can be shut off and the melt temperature maintained by pressure and friction within the barrel 530. Cooling devices such as fans, cooling jackets, fluid cooling devices such as heat exchanges, and the like (not shown) may also be included to maintain the temperature below a desired level.

The molten material 502 leaves the barrel 530 at an end 532 thereof and travels through an optional screen pack to remove contaminants in the melt. The screens are reinforced by a breaker plate 552 (a thick metal puck with many holes drilled through it) since the pressure at this point can be quite high (e.g., greater than approximately 30 MPa). The screen pack/breaker plate assembly also may act to create back pressure in the barrel 530. Back pressure may advantageously provide for relatively uniform melting and proper mixing of the material 502, and how much pressure is generated can be controlled by varying the screen pack composition (the number of screens, their wire weave size, and other parameters).

After passing through the breaker plate 532, the molten material 502 enters a die 560 through a feed pipe 550. The die 560 includes a cavity 562 configured to provide the final size, shape, and configuration to the extruded air electrode (or component thereof). The air electrode 514 can have any desired shape that has a continuous profile. For example, a hollow cylindrical air electrode may be formed, which may be used as an air electrode for a reaction tube of a flow battery such as that described above. Of course, the extrusion process may also be used to form relatively flat sheets of air electrode material as well, in addition to other possible shapes.

According to an exemplary embodiment, the die 560 is configured to allow the molten material 502 to flow evenly from the cylindrical or other profile of the feed pipe 550 to the desired profile of the air electrode. Uneven flow at this stage would produce an air electrode with unwanted stresses at certain points, which may cause undesired warpage upon cooling. The extruded air electrode 514 exits the die 560 through an opening or slot 564 in the end 566 of the die 560 and may then be cooled using any suitable method.

For a coin cell, the extruded air electrode may be produced as a flat sheet of material, after which the air electrode may be cut or stamped from the sheet in any desired shape. For a cylindrical cell where a cylindrical air electrode is desired, a flat sheet may be converted into a hollow cylinder by joining two of the edges of the flat sheet together after the sheet is cut to length or, alternatively (as described with respect to FIG. 27), the cylindrical electrode may be formed directly using a die that produces a hollow cylindrical air electrode. Other possibilities for air electrodes having differing configurations may be used according to other exemplary embodiments.

Although FIG. 26 illustrates an exemplary embodiment of a screw extruder, it will be appreciated by those reviewing the present disclosure that other configurations may be possible, and are intended to be included within the scope of this disclosure.

It should be understood that the screw extrusion process may be used to form air electrodes having any of a variety of configurations. For example, FIG. 27 illustrates a portion of a screw-type extruder 600 according an exemplary embodiment that is configured to produce an air electrode 620 having a hollow cylindrical configuration. A material 622 that has been melted as described above with respect to FIG. 26 is pushed into and through a slot 610 of an nozzle 608 of the extruder 600. A member 612 is located within the slot 610 such that a hole 624 (e.g., opening, aperture, channel, etc.) is formed through the middle of the material 622 as it cools, forming the hollow cylindrical air electrode 620. While the slot is shown having a circular cross-section, the slot may be configured to have any number of cross-sections according to other exemplary embodiments. According to other exemplary embodiments, the material 622 may be used to form an active layer or a gas diffusion layer of the air electrode 620.

An additional process that may be utilized in the formation of air electrodes is a slot die extrusion process.

Generally, slot die extrusion includes providing a current collector and one or more pastes or slurries intended to be fed through an extruder. Both the mesh current collector and the pastes or slurries are simultaneously fed through the extruder. The extruded metal-air battery components are then calendered to compact the active materials to the current collector and/or to adjust the thickness. In one exemplary embodiment, the mesh current collector is placed through an opening (e.g., slot, aperture, etc.) at a central location of the extruder.

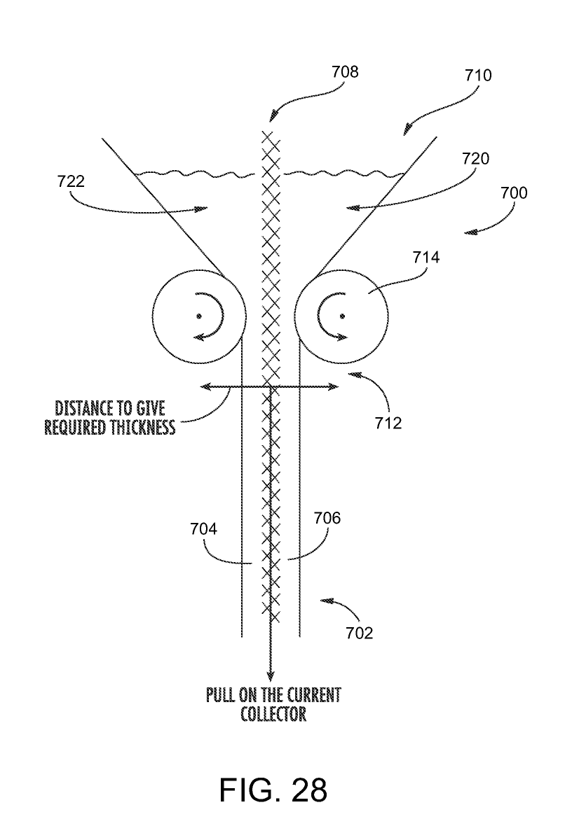

Referring to FIG. 28, a slot die extruder 700 is shown forming a complete air electrode 702 in a continuous process according to an exemplary embodiment. The air electrode 702 includes an active layer 704, a gas diffusion layer 706, and a current collector 708. The slot die extruder 700 is shown including an inlet 710, an outlet 712, and one or more rollers 714 for calendaring. A first paste or slurry 720 is provided that is intended to be formed into the gas diffusion layer 706, and a second paste or slurry 722 is provided that is intended to be formed into the active layer 704. The current collector 708 is placed into the extruder 700 (e.g., at a generally central location). The first paste or slurry 720 is placed into the inlet 710 of the extruder 700 to one side of the current collector 708 and the second paste or slurry 722 is placed into the inlet 710 of the extruder 700 to the other side of the current collector 708. The pastes or slurries 720, 722 and the current collector 708 are forced (e.g., pushed, moved, pulled, etc.) from the inlet 710 toward the outlet 712 of the extruder 700. The resultant air electrode 702 is shown having the current collector 708 disposed between the active layer 704 and the gas diffusion layer 706. According to some exemplary embodiments, the resultant air electrode is subsequently sintered at a temperature of approximately 200-320° C. in a press at a pressure of approximately 3000 psi. According to other exemplary embodiments, however, the air electrode may be sintered at any suitable temperature in a press at a pressure of approximately 1000 to 5000 psi. In some exemplary embodiments, the rollers for calendaring are not used in a slot die extrusion process. In some exemplary embodiments, other processes involving the application of heat and/or pressure are used during and/or after the slot die extrusion process. It should be noted that the slot die extrusion steps may be defined or grouped in other manners.

According to an exemplary embodiment, slot die extrusion is used to produce a gas diffusion layer including a current collector disposed therein. The current collector is disposed into an inlet of a slot die extruder between a first portion and a second portion of a gas diffusion layer slurry or paste. In one exemplary embodiment, the slurries or pastes on either side of the current collector are substantially the same (e.g., have substantially the same composition, etc.). In another exemplary embodiment, the slurries or pastes on either side of the current collector are different (e.g., the slurry portion intended to form the outside of the gas diffusion layer, e.g., the side/portion proximate to the air holes, may include more binder materials than the inside, providing for an improved oxygen diffusion rate, improved resistance to delamination, and/or improved prevention of electrolyte leakage through the gas diffusion layer). In some exemplary embodiments, the current collector may be disposed substantially in the center of the two extruded gas diffusion layer portions. According to other exemplary embodiments, the current collector is disposed closer to one of the side of the gas diffusion layer than the other.

Disposing the current collector within the gas diffusion electrode provides a number of benefits. First, this position substantially avoids exposing the current collector to the air side of the air electrode, reducing sealing challenges. Second, this position substantially avoids exposing the current collector on the active layer side of the air electrode, reducing delaminating issues for the air electrode.

According to an exemplary embodiment, slot die extrusion is used to produce an active layer including a current collector disposed therein. The current collector is disposed into an inlet of a slot die extruder between a first portion and a second portion of an active layer slurry or paste. In one exemplary embodiment, the slurries or pastes on either side of the current collector are substantially the same. In another exemplary embodiment, the slurries or pastes on either side of the current collector differ. For example, a paste composition with catalysts and binders suited predominantly for the oxygen evolution reaction can be extruded to one side of the mesh and a composition with catalysts and binders suited predominantly for the oxygen reduction reaction can be extruded to the other side of the mesh, providing a bifunctional air electrode with improved functionality because the oxygen evolution and the oxygen reduction reactions are separated into two different layers. In some exemplary embodiments, the current collector may be disposed substantially in the center of the two extruded active layer portions. In other exemplary embodiments, the current collector is disposed closer to one of the end of the active layer than the other.

According to an exemplary embodiment, slot die extrusion is used produce an air electrode including a current collector disposed therein, the current collector being disposed to between the active layer and the gas diffusion layer. When forming the air electrode, the slurry or paste to one side of the current collector includes material for the active layer, and the slurry or paste to the other side of the current collector includes material for the gas diffusion layer.

Injection molding and extrusion processes (e.g., screw extrusion, slot die extrusion) may be used alone or in combination with other processes involving the application of heat and/or pressure (e.g., calendaring, laminating, hot pressing, sintering, etc.) to the layers, which may be used to increase the binding properties of the layers. For example, by providing for cross-linking of the binders, these methods may increase the chemical and mechanical stability of the air electrode. In addition to helping to bind materials together, some of these processes (e.g., calendaring) may be used to smooth out a paste and/or to adjust the thickness of a layer of material. In some exemplary embodiments, a series of hard pressure rollers are used to calender and/or laminate one or more air electrode layers produced using an extrusion process. This calendering and/or lamination may take place at the end of an on-line process, or at another point in the process. It should also be noted that treatments involving the application of heat and/or pressure may also be used with air electrodes or layers thereof formed using processes other than an extrusion process (e.g., spray printing, spin coating, etc.).

According to an exemplary embodiment, an air electrode is formed using a multi-layer air electrode production process. The air electrode includes a gas diffusion layer, an active layer, and a current collector. The gas diffusion layer has a thickness of approximately 100-400 μm. The gas diffusion layer has a high hydrophobicity and includes more than 50 wt % PTFE. The remainder of the gas diffusion layer is carbon material to allow conductivity. The current collector is disposed within (e.g., embedded into) the gas diffusion layer. The active layer has a thickness of approximately 100-400 μm. The air electrode includes PTFE, oxygen evolution catalysts, oxygen reduction catalysts, and carbon material(s). The hydrophobicity of the active layer varies from approximately 50 wt % PTFE to approximately 10 wt % PTFE moving from the gas diffusion layer side of the active layer to the electrolyte side of the active layer. The concentration of oxygen evolution catalysts varies from approximately 20 wt % to 0 wt % moving from the gas diffusion layer side of the active layer to the electrolyte side of the active layer. The concentration of oxygen reduction catalysts varies from approximately 0 wt % to 20 wt % moving from the gas diffusion layer side of the active layer to the electrolyte side of the active layer. Moving from the gas diffusion layer side of the active layer to the electrolyte side of the active layer, the carbon materials transition from primarily high surface area carbons, to a higher concentration of high surface area carbons than low surface area carbons, to a lower concentration of higher surface area carbons than low surface area carbons, to primarily lower surface area carbons. These gradients can be achieved using a spin coating process, a spray printing process, a screen printing process, or any of the other multi-layer air electrode production processes described herein.

Some of the considerations that underlie the benefits provided by this exemplary construction will now be discussed. First, carbon variation (in a manner similar to that described above) allows for fast wetting or the active layer and creates an electrolyte layer within the active layer that helps prevent oxygen gas bubble formation in the electrolyte. Second, configuring the active layer such that the gas formed during the oxygen evolution catalyst reaction vents out of the gas diffusion layer, rather than into the electrolyte, helps prevent trapped gasses and the problems associated therewith (e.g., increased impedance, etc.). Third, increasing the PTFE content in the active layer moving toward the gas diffusion layer can slow down flooding by increasing hydrophobicity in the active layer. Fourth, reducing the concentration of oxygen reduction catalysts in the active layer moving toward the gas diffusion layer helps to limit flooding caused by high reaction rates close to the gas diffusion layer. Fifth, the gas diffusion layer is configured to good conductivity and provide for relatively efficient oxygen transportation without liquid penetrations.

The above-described air electrode production processes may be used alone or in combination with any traditional air electrode production process, any novel air electrode production processes disclosed herein, or any combination thereof. While some exemplary embodiments of these combinations have been described above, a non-limiting selection of additional exemplary combinations is provided below.

According to an exemplary embodiment, a first portion of an active layer of an air electrode is formed using a spin coating process. One or more patterned layers are then formed on surface of the air electrode using a screen printing process. The screen printed layers are disposed closer to the electrolyte than the spin coated layers. According to one exemplary embodiment, the screen-printed sublayers each include one or more blanks providing for improved venting of gasses from a metal-air battery.

According to an exemplary embodiment, an air electrode includes a gas diffusion layer, an active layer, and a current collector. The gas diffusion layer is formed using an extrusion process. The current collector is printed onto the gas diffusion layer using a screen printing process. The active layer is then spin coated onto the current collector.

According to an exemplary embodiment, an air electrode includes a gas diffusion layer, an active layer, and a current collector. The gas diffusion layer is formed using an injection molding process. The current collector is formed into the gas diffusion layer during the injection molding process. The active layer includes a plurality of sublayers formed using a printing method. The active layer sublayers may be printed directly onto the gas diffusion layer.

According to an exemplary embodiment, an air electrode includes a gas diffusion layer, an active layer, and a current collector. The active layer is formed using an injection molding process. The current collector is printed to the active layer. The gas diffusion layer is then spray printed onto the current collector and active layer.

According to any exemplary embodiment, an air electrode includes a gas diffusion layer, an active layer, and a current collector. The gas diffusion layer may be formed using any of the novel air electrode production processes described above (e.g., a printing process, a spin coating process, extrusion, injection molding, etc.), a traditional air electrode production process, or a combination thereof. The active layer may be formed using any of the novel air electrode production processes described above (e.g., a printing process, a spin coating process, extrusion, injection molding, etc.), a traditional air electrode production process, or a combination thereof. The current collector may be a printed current collector or traditional mesh. According to some exemplary embodiments, the air electrode is intended to also be the housing for a metal-air battery. According to some exemplary embodiments, the air electrode may be used in a button cell, a prismatic cell, a cylindrical cell, a flow cell, a fuel cell, or any other type of metal-air battery.

The above-described production methods allow for the use or new materials and/or new uses of materials in a metal-air battery. A non-exhaustive discussion of these materials and/or uses is presented below.

According to an exemplary embodiment, a metal-air battery may include an ion exchange membrane. Ion exchange membranes are generally selective for the transport of either cations or anions. In addition to preventing solid particle (e.g., zinc dendrites) and ion transport, ion exchange membranes may further help achieve a desired selectivity for a gas (e.g., for oxygen, water vapor, carbon-dioxide, etc.) within a metal-air battery or a portion thereof.

According to an exemplary embodiment, a sublayer that is an ion exchange membrane is printed into or onto an air electrode of a metal-air battery. As noted above, utilizing a printing process to apply an ion exchange membrane provides numerous benefits, including, but not limited to, the ability to control the amount and positioning of the ion exchange materials (e.g., polystyrene, polyether ether ketone (PEEK), etc.) within a sublayer. According to some exemplary embodiments, ion exchange materials may be disposed in hydrophilic channels, form the hydrophilic channels, and/or form substantially the entire hydrophilic structure of the air electrode.

According to one exemplary embodiment, a coating applied to form a sublayer includes a plurality of ion exchange polymers. The coating may further include PTFE, carbon, and/or catalysts. According to another exemplary embodiment, two coatings material are provided, one including the ion exchange polymers and the other corresponding to any other air electrode sublayer component material, both of which are applied simultaneously.

The resultant ion exchange membrane forms a solid polymer that limits (e.g., controls, regulates, etc.) the transport of liquids within the air electrode. By reducing the transport of liquids, flooding can be reduced and the lifetime of the air electrode extended. By providing for control of the three phase boundary of the air electrode, an ion exchange membrane may also help separate the oxygen reduction reaction from the oxygen evolution reaction. Additionally, integration of the ion exchange material into the air electrode will limit diffusion of cations (e.g., particles and salts) into and out of the air electrode. By reducing this diffusion, cross contamination between the anode and the cathode for any metal air battery can be limited and controlled.

According to an exemplary embodiment, a sublayer that is an ion exchange membrane is spin coated into/onto an air electrode of a metal-air battery. According to other exemplary embodiments, any of the above-described printing processes may be used to apply/form an ion exchange membrane.

According to an exemplary embodiment, more than one ion exchange membrane may be formed into an air electrode. According to one exemplary embodiment, two or more of the same type of ion exchange membranes may be incorporated. According to another exemplary embodiment, two or more different types of ion exchange membranes may be incorporated. These membranes may be disposed adjacent to one another or may be spaced a distance apart.

In some embodiments, gas selective membranes may be used to control the transport of certain ions or other materials within an air electrode (e.g., oxygen, CO₂, etc.).

The inventors have unexpectedly determined that a gas selective material may be utilized as a binder in combination with more conventional binders to improve the selectivity for one or more gasses. The gas selective material may be included throughout the air electrode or a portion thereof (e.g., a primary layer, a sublayer, etc.).

The inventors have also unexpectedly determined that catalyst films may be formed and utilized to prevent the transport of certain gases.

According to an exemplary embodiment, siloxane is utilized as a binder in combination with other binders (e.g., PE, PP, PTFE, etc.) in an air electrode in order to improve oxygen diffusion. In one exemplary embodiment, the siloxane binder is utilized in combination with a silver catalyst (e.g., Raney Ag) that is not supported by a carbon carrier. This combination provides for the avoidance of CO₂ formation during charging due to the degradation of a carbon. It should also be noted that the silver catalysts would provide a relatively high transport rate for oxygen. The siloxane can thus act as a support for the deposition of a thin solid silver film to protect against any CO₂ or H₂O interaction without preventing oxygen from moving through the air electrode. The silver film may be applied/formed using chemical vapor deposition or other suitable thin film coating methods.

According to an exemplary embodiment, cathode materials used in alkaline batteries (e.g., Ni(OH)2 that can react to NiOOH) are utilized to contribute to the cathode reaction. These materials may be incorporated into the active layer and/or the gas diffusion layer of an air electrode as a conductive filler.

As discussed above, ionic liquids may be used as an electrolyte in a metal-air battery or in combination with other electrolytes. Ionic liquids have different viscosities, wetting angles, hydrophobicities, etc. than traditional electrolytes used in metal air batteries. Accordingly, existing air electrodes and production methods, which are configured for use with alkaline electrolytes, do not allow ionic liquids to be utilized to their full advantage. The inventors' novel air electrode production processes do, however, allow for one to more fully utilize ionic liquids, and, accordingly, improve the performance of metal-air batteries.

Because of their resistance to drying out, ionic liquid electrolytes allow new metal-air battery configurations and applications. Ionic liquid electrolytes provide the option to have a more open air electrode structure because there is less need for humidity management, provide increased surface area for the oxygen reaction because less binder material can be used, and provide for more catalysts to be included in the air electrode because larger carbon particles may be used or may be used in greater proportions.

According to an exemplary embodiment, a metal-air battery includes an ionic liquid electrolyte. According to some exemplary embodiments, the ionic liquid electrolyte is included directly in the air electrode. For example, the ionic liquid may be included in the coating material for an air electrode sublayer to be applied using a printing process (e.g., spray, screen, etc.).

According to an exemplary embodiment, an ionic liquid electrolyte and a standard electrolyte are both included in a metal air battery. The ionic liquid electrolyte is impregnated into one or more sublayers located at the side of the air electrode proximate to the metal anode. The standard electrolyte (e.g., KOH) is included everywhere else. The standard electrolyte would be substantially isolated by the ionic liquid electrolyte, providing gas transport-related (e.g., CO₂, water vapor) benefits.

The inventors have unexpectedly determined that deep eutectic solvents (sometimes abbreviated “DES”) may be advantageously used as the electrolyte in a metal-air battery or included in the electrolyte in a metal-air battery. Further, the use of deep eutectic solvents in the electrolyte of metal-air batteries allows for the use of metal-air batteries in many applications where metal-air battery use was previously foreclosed or complicated by humidity management issues.

A deep eutectic solvent is a type of ionic solvent composed of a mixture which forms a eutectic with a melting point much lower than either of the individual components (e.g., quaternary ammonium salts with hydrogen donors such as amines and carboxylic acids; chlorine chloride and urea; etc.). A deep eutectic solvent is able to dissolve metal salts (e.g., lithium chloride, copper(II)oxide, etc.) and is conductive. Compared to ordinary solvents, deep eutectic solvents also have a low volatility, are non-flammable, are relatively inexpensive to produce, and may be biodegradable.

According to an exemplary embodiment, a metal-air battery includes an electrolyte that includes a deep eutectic solvent and 20% 7.5M KOH. The deep eutectic solvent includes glycerol and acetylcholine chloride. According to preliminary test results, this electrolyte exhibited 17% water uptake in 50°/50% RH. The electrolyte formed a clear, stable solution with good electrochemical properties when tested. According to other exemplary embodiments, an electrolyte may be or include a deep eutectic solvent that is a combination of glycerol and choline chloride, that is a combination of glycerol and ethylamine*HlC (the hydrochloric salt of ethylamine), that is a combination of urea and choline chloride, or that is a combination of urea and choline chloride and sodium sulfate. According to still other exemplary embodiments, other deep eutectic solvents may be included in an electrolyte in a metal-air battery. According to some exemplary embodiments, a deep eutectic solvent may be combined with choline hydroxide and/or sodium sulfate.

According to an exemplary embodiment, a metal-air battery includes an anode and a cathode. The anode includes a zinc paste mixed with KOH. An ion exchange membrane including PEEK separates an anode electrolyte from a cathode electrolyte, replacing a conventional separator. The cathode electrolyte includes a DES, water, and KOH. According to some exemplary embodiments, to more desirably position the DES relative to the air electrode, a thin (e.g., 100-200 μm) non-woven absorbing layer is disposed on the active layer of the air electrode.

There are difficulties associated with sealing metal-air batteries because the air electrode has to be open to one side in order to allow oxygen into the battery. Using conventional sealing methods (e.g., gaskets, gluing, etc.) requires that a high degree of control is exercisable over the thickness tolerances. Any variation in production can result in large scrap rates. In addition, metal-air batteries often need to be stored for a long time before shipment in order to assure that the quality of the seal is sufficient. Further, glue sealing processes are complex and the glue selections may be limited by the high alkalinity of the electrolyte.

The inventors have discovered innovative solutions to seal the air electrode. These solutions involve hot stamping and/or ultrasonic welding. As the air electrode is porous, a first plastic material (e.g., PP or PE) can be hot stamped or ultrasonically welded to the air electrode (so long as the melting point of the plastic material is lower than the melting point of PTFE, if used, or equal to the melting point of PP or PE, if used). The first plastic material melts and fills a portion of the pore structure of the air electrode in and/or along the sealed edge. The resultant seal is stronger than the internal structure of the air electrode (e.g., fracture of the air electrode occurs before the seal breaks).

According to an exemplary embodiment, sealing methods including hot stamping and/or ultra sonic welding allow for creation of a soft pouch metal air battery. The air electrode or electrodes can be sealed to a plastic foil (e.g., sheet, etc.) configured to be folded into a pouch having an opening (e.g., at one end of the pouch). Metal anode material and electrolyte are inserted into the pouch through the opening to form a metal air battery. The inventors further discovered that a current collector mesh or foil can be lead out of the pouch to draw current out of the battery and then be resealed (e.g., by applying a plastic tab around them, using hot stamping or ultrasonic welding to melt the plastic around the current collector, etc.). Resealing the current collector helps prevent leakage. In some exemplary embodiments, porous plastic materials may be welded to the air electrode to provide venting paths for gas trapped within the metal-air battery.

According to an exemplary embodiment, the soft pouch metal-air battery provides for use of metal-air batteries in new applications, particularly those where a soft pouch battery is required or beneficial (e.g., thin, flexible batteries; etc.).

According to an exemplary embodiment, hot stamping or welding may be used for housings utilizing thicker plastic materials. In some exemplary embodiments, the air electrode may be welded or hot stamped directly to the housing.

Various combinations of materials, structures, application methods, methods of manufacture, and applications discussed herein may be used within the scope of this disclosure. Also, while the description included herein is primarily directed to batteries, the concepts disclosed also apply to fuels cells and other electrochemical conversion devices having desired configurations.

The metal-air batteries described herein may be used singularly or in combination, and may be integrated into or with various systems or devices to improve efficiency, address energy demands, etc. The metal-air batteries described herein may be used in a wide range of applications. For example, the battery may be used in large systems and devices (e.g., power levels in the kW range), where improving environmental aspects (e.g., the environment external to the battery and the effect of this environment on the chemical reaction within the battery) of the metal-air battery may provide for significant gains in performance (e.g., energy conversion and storage at high efficiency). Also, the battery may be used in smaller systems (power levels in the W range), where advances in consumer electronics provide opportunities for energy conversion and storage provided in a desirable size and having a relatively long lifespan

Coin cells, prismatic cells, and cylindrical cells such as those described herein may be used in any application where such batteries may find utility, including, for example, hearing aids, headsets (e.g., Bluetooth or other wireless headsets), watches, medical devices, and other electronic devices such as (but not limited to) cameras, portable music players, laptops, phones (e.g., cellular phones), toys, portable tools. Metal-air flow batteries can provide energy storage and conversion solutions for peak shaving, load leveling, and backup power supply (e.g., for renewable energy sources such as wind, solar, and wave energy). The flow batteries may allow for the reduction of energy generation related emissions (e.g., greenhouse gases), and may also be used in a manner intended to improve the efficiency of the public utility sector. Flow batteries may also be used in for providing backup power, for example, for residential or commercial buildings such as homes or office buildings. In the automotive context, metal-air flow batteries may also be used to provide motive power for an electric vehicle (e.g., a hybrid-electric vehicle, plug-in hybrid electric vehicle, pure electric vehicle, etc.), to provide backup power for the battery (e.g., as a range-extender), to provide power for other vehicle electric loads such as the electronics, GPS/navigation systems, radios, air conditioning, and the like within the vehicle, and to provide for any other power needs within the vehicle (it should be noted that metal-air batteries having prismatic, cylindrical, or other configurations may also be used to provide power in the foregoing vehicle applications, for example, where a number of batteries are used in conjunction with each other to form a battery pack, module, or system).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the construction and arrangement of the metal-air battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present inventions.

What is claimed is:

1. A method of providing an air electrode for a metal-air battery, the method comprising:
forming a plurality of layers of the air electrode, wherein the plurality of layers comprise an active layer and a gas diffusion layer, and wherein forming at least one of the active layer or the gas diffusion layer comprises:
forming a first sublayer having a first concentration of a first material; and
forming a second sublayer having at least one of a second concentration of the first material that differs from the first concentration or a second material that differs from the first material.

2. The method of claim 1, wherein the first sublayer and the second sublayer are part of the active layer, and wherein at least one of the first material or the second material is a catalyst material.

3. The method of claim 2, further comprising:
providing an electrolyte in the metal-air battery; and
providing the air electrode in the metal-air battery such that the first sublayer is nearer to the electrolyte than the second sublayer;
wherein the first concentration is higher than the second concentration.

4. The method of claim 1, wherein the first sublayer and the second sublayer are part of the active layer, and wherein at least one of the first material or the second material is a surfactant material.

5. The method of claim 4, further comprising:
providing an electrolyte in the metal-air battery; and
providing the air electrode in the metal-air battery such that the first sublayer is nearer to the electrolyte than the second sublayer;
wherein the first sublayer is formed using a first surfactant material and the second sublayer is formed using a second surfactant material, and wherein the first surfactant material includes surfactants that are removable at a higher temperature than surfactants of the second surfactant material.

6. The method of claim 1, further comprising:
providing an electrolyte in the metal-air battery; and
providing the air electrode in the metal-air battery such that the first sublayer is nearer to the electrolyte than the second sublayer;
wherein the first sublayer is formed using a non-carbon material and the second sublayer is formed using a carbon material.

7. The method of claim 1, further comprising printing a hydrophobic layer about a periphery of at least one of the first sublayer and the second sublayer.

8. A metal-air battery comprising:
an air electrode comprising a plurality of layers, wherein the plurality of layers comprise an active layer and a gas diffusion layer, wherein at least one of the active layer or the gas diffusion layer comprises:
a first sublayer having a first concentration of a first material; and
a second sublayer having at least one of a second concentration of the first material that differs from the first concentration or a second material that differs from the first material.

9. The metal-air battery of claim 8, wherein the first sublayer and the second sublayer are part of the active layer, and wherein at least one of the first material or the second material is a catalyst material.

10. The metal-air battery of claim 9, further comprising an electrolyte, wherein the air electrode is provided such that the first sublayer is nearer to the electrolyte than the second sublayer, and wherein the first concentration is higher than the second concentration.

11. The metal-air battery of claim 8, wherein the first sublayer and the second sublayer are part of the active layer, and wherein at least one of the first material or the second material is a surfactant material.

12. The metal-air battery of claim 11, further comprising an electrolyte, wherein the air electrode is provided such that the first sublayer is nearer to the electrolyte than the second sublayer, wherein the first sublayer comprises first surfactant material and the second sublayer comprises a second surfactant material, and wherein the first surfactant material includes surfactants that are removable at a higher temperature than surfactants of the second surfactant material.

13. The metal-air battery of claim 8, further comprising an electrolyte, wherein the air electrode is provided such that the first sublayer is nearer to the electrolyte than the second sublayer, and wherein the first sublayer comprises a non-carbon material and the second sublayer comprises a carbon material.

14. The metal-air battery of claim 8, wherein the air electrode further comprises a hydrophobic layer positioned about a periphery of at least one of the first sublayer and the second sublayer.

15. A method of providing an air electrode of a metal-air battery, the method comprising:
forming a layer of an air electrode such that a gradient of a material is formed in at least a portion of the layer by varying a concentration of the material deposited between a first portion of the layer and a second portion of the layer.

16. The method of claim 15, wherein the material comprises a first material, and wherein the gradient is formed by:
forming a first sublayer having a first concentration of the material; and
forming a second sublayer having at least one of a second concentration of the first material that differs from the first concentration or a second material that differs from the first material.

17. The method of claim 16, wherein the first sublayer and the second sublayer are part of the active layer, and wherein at least one of the first material or the second material is a catalyst material.

18. The method of claim 17, further comprising:
providing an electrolyte in the metal-air battery; and
providing the air electrode in the metal-air battery such that the first sublayer is nearer to the electrolyte than the second sublayer;
wherein the first concentration is higher than the second concentration.

19. The method of claim 16, wherein the first sublayer and the second sublayer are part of the active layer, and wherein at least one of the first material or the second material is a surfactant material.

20. The method of claim 19, further comprising:
providing an electrolyte in the metal-air battery; and
providing the air electrode in the metal-air battery such that the first sublayer is nearer to the electrolyte than the second sublayer;
wherein the first sublayer is formed using a first surfactant material and the second sublayer is formed using a second surfactant material, and wherein the first surfactant material includes surfactants that are removable at a higher temperature than surfactants of the second surfactant material.

21. The method of claim 16, further comprising:
providing an electrolyte in the metal-air battery; and
providing the air electrode in the metal-air battery such that the first sublayer is nearer to the electrolyte than the second sublayer;
wherein the first sublayer is formed using a non-carbon material and the second sublayer is formed using a carbon material.

22. The method of claim 16, further comprising printing a hydrophobic layer about a periphery of at least one of the first sublayer and the second sublayer.
